(19) United States
(12) Patent Application Publication
(10) Pub. No.: US 2025/0375796 A1
(43) Pub. Date: Dec. 11, 2025

(54) SYSTEMS, METHODS, AND ASSEMBLIES FOR CLEANING AN OPHTHALMIC LENS

(71) Applicant: Alcon Inc., Fribourg (CH)

(72) Inventors: William Keith JOHNSON, Fort Worth, TX (US); Christine Anne MATHEW, Fort Worth, TX (US); Waraporn KAMBHIRANOND, Fort Worth, TX (US); Christopher HOLDERNESS, Fort Worth, TX (US); Raza Ulabdin SHAH, San Francisco, CA (US); Daniel FELLHAUER, Grosswallstadt (DE); David Heemyung KIM, Grosswallstadt (DE)

(73) Assignee: Alcon Inc., Fribourg (CH)

(21) Appl. No.: 19/228,372

(22) Filed: Jun. 4, 2025

Related U.S. Application Data
(60) Provisional application No. 63/656,310, filed on Jun. 5, 2024.

(51) Int. Cl. B08B 1/12; B08B 1/30; F26B 21/00

(52) U.S. Cl. CPC B08B 1/12; B08B 1/30; F26B 21/004

(57) ABSTRACT

Disclosed are systems, methods, and assemblies for cleaning an ophthalmic lens. In one aspect, an automated system is disclosed comprising a brushing assembly, a rinsing assembly, and a drying assembly. The brushing assembly can comprise a first brush head facing a second brush head. The first brush head can be coupled to a first vibrating motor assembly configured to vibrate the first brush head and the second brush head can be coupled to a second vibrating motor assembly configured to vibrate the second brush head.

### CROSS-REFERENCE TO RELATED APPLICATION

6 This application claims the benefit of U.S. Provisional Application No. 63/656,310 filed on Jun. 5, 2024, the content of which is incorporated herein by reference in its entirety.

### TECHNICAL FIELD

The present disclosure relates generally to the field of ophthalmic lenses, and, more specifically, to systems, methods, and assemblies for cleaning an ophthalmic lens.

### BACKGROUND

A cataract is a condition involving the clouding over of the normally clear lens of a patient's eye. Cataracts occur as a result of aging, hereditary factors, trauma, inflammation, metabolic disorders, or exposure to radiation. Age-related cataract is the most common type of cataracts. In treating a cataract, the surgeon removes the crystalline lens matrix from the patient's lens capsule and replaces it with an intraocular lens (IOL).

However, IOLs can accumulate debris or contaminants during the manufacturing process and often require an end-step cleaning process. This is especially true for the optic portion of the IOL.

Current manual cleaning procedures often involve scrubbing the manufactured lens using a brush and surfactant solution. However, such manual cleaning procedures are time-consuming, labor-intensive, and prone to manual error.

Automated cleaning systems can involve rotating the lens in an ultrasonic bath containing a cleaning solution. However, because some ophthalmic lenses are made of soft delicate materials, the lens material may absorb ultrasonic energy which can adversely affect the optical quality of the lens.

Therefore, a solution is needed which addresses the aforementioned problems. Such a solution should not be overly complicated and should allow the cleaning process to be applied to different types of ophthalmic lenses.

### SUMMARY

Disclosed herein are systems, methods, and assemblies for cleaning an ophthalmic lens. In some embodiments, an automated system for cleaning an ophthalmic lens is disclosed. The system can comprise a brushing assembly comprising a first brush head coupled to a first vibrating motor assembly configured to vibrate the first brush head and a second brush head coupled to a second vibrating motor assembly configured to vibrate the second brush head. The first brush head can face the second brush head. The first brush head can be separated from the second brush head by a lens receiving space. At least a part of the first brush head and at least a part of the second brush head can be configured to directly contact and brush the ophthalmic lens when the ophthalmic lens is positioned within the lens receiving space in between the first brush head and the second brush head as the brush heads vibrate.

The system can further comprise a rinsing assembly comprising at least one rinse nozzle configured to spray the ophthalmic lens with a rinsing liquid after the ophthalmic lens is brushed by the brushing assembly and a drying assembly comprising at least one air dry nozzle configured to blow dry the ophthalmic lens after the ophthalmic lens is sprayed by the rinsing assembly.

In some embodiments, the first brush head can comprise a plurality of first brush bristles and the second brush head can comprise a plurality of second brush bristles. The plurality of first brush bristles and the plurality of second brush bristles can be made of polymeric fibers.

In some embodiments, the polymeric fibers can be polyethylene terephthalate (PET) fibers.

In some embodiments, the plurality of first brush bristles can be arranged in a frustonical shape and the plurality of second brush bristles can be arranged in a frustonical shape.

In some embodiments, the first brush head can comprise a first brush head distal end and the second brush head can comprise a second brush head distal end. The brushing assembly can further comprise a a first electric sliding actuator configured to translate the first brush head toward the second brush head when the ophthalmic lens is positioned within the lens receiving space and a second electric sliding actuator configured to translate the second brush head toward the first brush head when the ophthalmic lens is positioned within the lens receiving space. The first electric sliding actuator and the second electric sliding actuator can be configured to translate the brush heads toward one another until a brush gap separates the first brush head distal end from the second brush head distal end.

In some embodiments, the brush gap can be between 0.3 mm and 2.0 mm.

In some embodiments, the ophthalmic lens can comprise an optic portion having an optic portion thickness and the brush gap can be less than the optic portion thickness.

In some embodiments, the system can further comprise a surfactant drip configured to drip a surfactant solution onto at least part of the ophthalmic lens while the ophthalmic lens is being brushed.

In some embodiments, the surfactant solution can be a 0.5% (v/v) solution comprising polysorbate 20.

In some embodiments, the surfactant solution can be dripped onto the ophthalmic lens at a rate of between 3 mL per minute and 7 mL per minute.

In some embodiments, the rinsing liquid can be deionized water.

In some embodiments, the ophthalmic lens can be configured to be brushed by the first brush head and the second brush head for between 60 seconds and 120 seconds.

In some embodiments, the ophthalmic lens can be configured to be rinsed for between 60 seconds and 200 seconds.

In some embodiments, the ophthalmic lens can be configured to be blow dried for between 20 seconds and 100 seconds.

In some embodiments, the at least one air dry nozzle can be an air knife and the air knife can be configured to blow dry the ophthalmic lens using compressed air.

In some embodiments, the system can further comprise a lens carrier configured to hold the ophthalmic lens in position while the ophthalmic lens is being cleaned.

In some embodiments, the lens carrier can be configured to hold the ophthalmic lens by one or more haptics of the ophthalmic lens.

In some embodiments, the lens carrier can comprise a first carrier part and a second carrier part. The ophthalmic lens can be configured to be positioned in between the first carrier part and the second carrier part when the first carrier part is detachably coupled to the second carrier part.

In some embodiments, the first carrier part can be configured to be detachably coupled to the second carrier part via one or more magnets.

In some embodiments, the first carrier part can comprise at least a first window and the second carrier part can comprise at least a second window. The first window and the second window can be configured to expose the ophthalmic lens during cleaning.

In some embodiments, the first carrier part can further comprise a first pair of securement bars. The second carrier part can further comprise a second pair of securement bars. The first pair of securement bars and the second pair of securement bars can be configured to secure the ophthalmic lens when the first carrier part is detachably coupled to the second carrier part.

In some embodiments, the system can further comprise a robotic arm configured to transport the lens carrier holding the ophthalmic lens to at least one of the brushing assembly, the rinsing assembly, and the drying assembly.

In some embodiments, the robotic arm can comprise multiple serial linkages connected by articulating joints. The robotic arm can comprise an end effector configured to grasp the lens carrier.

In some embodiments, the robotic arm can be configured to translate the lens carrier laterally in a back-and-forth motion when the ophthalmic lens is being brushed by the first brush head and the second brush head.

In some embodiments, the robotic arm can be configured to translate the lens carrier vertically in an up-and-down motion when the ophthalmic lens is being sprayed by the rinsing assembly.

In some embodiments, the robotic arm can be configured to translate the lens carrier vertically in an up-and-down motion when the ophthalmic lens is being blow dried by the drying assembly.

In some embodiments, the rinsing assembly can further comprise a first rinse nozzle comprising a first spray nozzle port and a second rinse nozzle comprising a second spray nozzle port. The first spray nozzle port can face the second spray nozzle port to spray the ophthalmic lens with the rinsing liquid from opposite sides.

In some embodiments the drying assembly can further comprise a first air dry nozzle comprising a first air nozzle port and a second air dry nozzle comprising a second air nozzle port. The first air nozzle port can face the second air nozzle port to blow dry the ophthalmic lens from opposite sides.

In some embodiments, the ophthalmic lens can be made in part of an acrylic material.

In some embodiments, the ophthalmic lens can be an accommodating intraocular lens. In other embodiments, the ophthalmic lens can be a non-accommodating intraocular lens.

In some embodiments, a method of automatically cleaning an ophthalmic lens is disclosed. The method can comprise brushing a first side of the ophthalmic lens using a first brush head by vibrating the first brush head using a first vibrating motor assembly coupled to the first brush head and brushing a second side of the ophthalmic lens using a second brush head by vibrating the second brush head using a second vibrating motor assembly coupled to the second brush head. The first brush head can face the second brush head. The method can further comprise spraying the ophthalmic lens with a rinsing liquid using at least one rinse nozzle after the ophthalmic lens is brushed and blow drying the ophthalmic lens with at least one air dry nozzle after the ophthalmic lens is sprayed.

In some embodiments, the first brush head can comprise a plurality of first brush bristles. The second brush head can comprise a plurality of second brush bristles. The plurality of first brush bristles and the plurality of second brush bristles can be made of polymeric fibers.

In some embodiments, the polymeric fibers can be polyethylene terephthalate (PET) fibers.

In some embodiments, the plurality of first brush bristles can be arranged in a frustonical shape and the plurality of second brush bristles can be arranged in a frustonical shape.

In some embodiments, the method can further comprise translating the first brush head toward the second brush head when the ophthalmic lens is positioned within a lens receiving space using a first electric sliding actuator and translating the second brush head toward the first brush head when the ophthalmic lens is positioned within the lens receiving space using a second electric sliding actuator. The first brush head can comprise a first brush head distal end and the second brush head can comprise a second brush head distal end. The first electric sliding actuator and the second electric sliding actuator can be configured to translate the brush heads toward one another until a brush gap separates the first brush head distal end from the second brush head distal end.

In some embodiments, the brush gap can be between 0.3 mm and 2.0 mm.

In some embodiments, the ophthalmic lens can comprise an optic portion having an optic portion thickness. The brush gap can be less than the optic portion thickness.

In some embodiments, the method can comprise dripping a surfactant solution onto at least part of the ophthalmic lens while the ophthalmic lens is being brushed using a surfactant drip.

In some embodiments, the surfactant solution can be a 0.5% (v/v) solution comprising polysorbate 20.

In some embodiments, the method can further comprise dripping the surfactant solution onto at least part of the ophthalmic lens at a rate of between 3 mL per minute and 7 mL per minute.

In some embodiments, the method can further comprise brushing the ophthalmic lens using the first brush head and the second brush head for between 60 seconds and 120 seconds.

In some embodiments, the rinsing liquid can be deionized water.

In some embodiments, the method can further comprise rinsing the ophthalmic lens for between 60 seconds and 200 seconds.

In some embodiments, the method can further comprise blow drying the ophthalmic lens for between 20 seconds and 100 seconds.

In some embodiments, the at least one air dry nozzle can be an air knife and the air knife can be configured to blow dry the ophthalmic lens using compressed air.

In some embodiments, the method can further comprise securing or holding the ophthalmic lens using a lens carrier while the ophthalmic lens is being cleaned.

In some embodiments, the method can further comprise securing or holding the ophthalmic lens by one or more haptics of the ophthalmic lens.

In some embodiments, the method can further comprise placing the ophthalmic lens on a first carrier part of the lens carrier and detachably coupling a second carrier part of the lens carrier to the first carrier part. The ophthalmic lens can be positioned in between the first carrier part and the second carrier part when the second carrier part is detachably coupled to the first carrier part.

In some embodiments, the method can further comprise detachably coupling the second carrier part to the first carrier part via one or more magnets.

In some embodiments, the first carrier part can comprise at least a first window and the second carrier part can comprise at least a second window. The first window and the second window can be configured to expose the ophthalmic lens during cleaning.

In some embodiments, the method can further comprise positioning the ophthalmic lens on the first carrier part such that at least part of one or more haptics of the ophthalmic lens are on a first pair of securement bars of the first carrier part and securing the ophthalmic lens within the lens carrier by pressing a second pair of securement bars of the second carrier part against the first pair of securement bars. The method can also comprise detachably coupling the second carrier part to the first carrier part.

In some embodiments, the method can also comprise transporting the lens carrier holding the ophthalmic lens to be brushed, sprayed, and blow dried using a robotic arm.

In some embodiments, the method can further comprise grasping the lens carrier using an end effector of the robotic arm. The robotic arm can further comprise multiple serial linkages connected by articulating joints.

In some embodiments, the method can also comprise translating the lens carrier laterally in a back-and-forth motion when the ophthalmic lens is being brushed by the first brush head and the second brush head.

In some embodiments, the method can further comprise translating the lens carrier vertically in an up-and-down motion when the ophthalmic lens is being sprayed by the at least one rinse nozzle.

In some embodiments, the method can further comprise translating the lens carrier vertically in an up-and-down motion when the ophthalmic lens is being blow dried with the at least one air dry nozzle.

In some embodiments, the method can further comprise spraying the ophthalmic lens with a first rinse nozzle comprising a first spray nozzle port and a second rinse nozzle comprising a second spray nozzle port. The first spray nozzle port can face the second spray nozzle port to spray the ophthalmic lens with the rinsing liquid from opposite sides.

In some embodiments, the method can also comprise blow drying the ophthalmic lens with a first air dry nozzle comprising a first air nozzle port and a second air dry nozzle comprising a second air nozzle port. The first air nozzle port can face the second air nozzle port to blow dry the ophthalmic lens from opposite sides.

Also disclosed is a brushing assembly for cleaning an ophthalmic lens. The brushing assembly can comprise a first brush head, a first vibrating motor assembly coupled to the first brush head and configured to vibrate the first brush head, a second brush head facing the first brush head, and a second vibrating motor assembly coupled to the second brush head and configured to vibrate the second brush head. The first brush head can be separated from the second brush head by a lens receiving space. At least a part of the first brush head and at least a part of the second brush head can be configured to directly contact and brush the ophthalmic lens when the ophthalmic lens is positioned within the lens receiving space in between the first brush head and the second brush head as the brush heads vibrate.

In some embodiments, the first brush head can comprise a plurality of first brush bristles and the second brush head can comprise a plurality of second brush bristles. The plurality of first brush bristles and the plurality of second brush bristles can be made of polymeric fibers.

In some embodiments, the polymeric fibers can be polyethylene terephthalate (PET) fibers.

In some embodiments, the plurality of first brush bristles can be arranged in a frustonical shape and the plurality of second brush bristles can be arranged in a frustonical shape.

In some embodiments, the brushing assembly can further comprise a first electric sliding actuator configured to translate the first brush head toward the second brush head when the ophthalmic lens is positioned within the lens receiving space and a second electric sliding actuator configured to translate the second brush head toward the first brush head when the ophthalmic lens is positioned within the lens receiving space. The first brush head can comprise a first brush head distal end and the second brush head can comprise a second brush head distal end. The first electric sliding actuator and the second electric sliding actuator can be configured to translate the brush heads toward one another until a brush gap separates the first brush head distal end from the second brush head distal end.

In some embodiments, the brush gap can be between 0.3 mm and 2.0 mm.

In some embodiments, the ophthalmic lens can comprise an optic portion having an optic portion thickness. The brush gap can be less than the optic portion thickness.

In some embodiments, the brushing assembly can comprise a surfactant drip configured to drip a surfactant solution onto at least part of the ophthalmic lens while the ophthalmic lens is being brushed.

In some embodiments, the surfactant solution can be a 0.5% (v/v) solution comprising polysorbate 20.

In some embodiments, the surfactant solution can be dripped onto the ophthalmic lens at a rate of between 3 mL per minute and 7 mL per minute.

In some embodiments, the ophthalmic lens can be configured to be brushed by the first brush head and the second brush head for between 60 seconds and 120 seconds.

In some embodiments, the brushing assembly can further comprise a lens carrier configured to hold the ophthalmic lens in position while the ophthalmic lens is being brushed.

In some embodiments, the lens carrier can be configured to hold the ophthalmic lens by one or more haptics of the ophthalmic lens.

In some embodiments, the lens carrier can comprise a first carrier part and a second carrier part. The ophthalmic lens can be configured to be positioned in between the first carrier part and the second carrier part when the first carrier part is detachably coupled to the second carrier part.

In some embodiments, the first carrier part can be configured to be detachably coupled to the second carrier part via one or more magnets.

In some embodiments, the first carrier part can comprise at least a first window and the second carrier part can comprise at least a second window. The first window and the second window can be configured to expose the ophthalmic lens during cleaning.

In some embodiments, the first carrier part can further comprise a first pair of securement bars and the second carrier part can further comprise a second pair of securement bars. The first pair of securement bars and the second pair of securement bars can be configured to secure the ophthalmic lens when the first carrier part is detachably coupled to the second carrier part.

### BRIEF DESCRIPTION OF THE DRAWINGS

FIG. 1A illustrates a top plan view of one embodiment of an ophthalmic lens that can be cleaned by the automated cleaning system disclosed herein.

FIG. 1B illustrates an exploded view of the ophthalmic lens.

FIG. 1C illustrates a side of one embodiment of an optic portion of the ophthalmic lens.

FIG. 1D illustrates an exploded view of another embodiment of an ophthalmic lens that can be cleaned by the automated cleaning system disclosed herein.

FIG. 2 illustrates one embodiment of an automated cleaning system for cleaning ophthalmic lenses.

FIG. 3A illustrates one embodiment of a lens carrier separated into its two constituent parts.

FIG. 3B illustrates one embodiment of a robotic end effector of a robotic arm of the automated cleaning system grasping a lens carrier carrying an ophthalmic lens.

FIG. 4A illustrates the lens carrier positioned in between brushes of a brushing assembly of the automated cleaning system.

FIG. 4B is a close-up view of one embodiment of two brushes of the brushing assembly.

FIG. 5 illustrates one embodiment of a rinsing assembly of the automated cleaning system in operation.

FIG. 6 illustrates one embodiment of a drying assembly of the automated cleaning system blow drying an ophthalmic lens carried by the lens carrier.

FIG. 7 are black-and-white single spot and bright field images showing an optic portion of one embodiment of an ophthalmic lens before and after being cleaned by the automated cleaning system.

### DETAILED DESCRIPTION

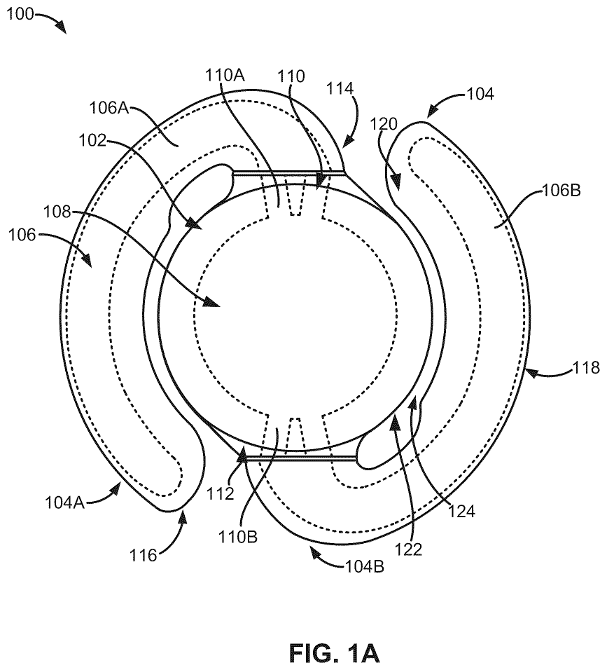

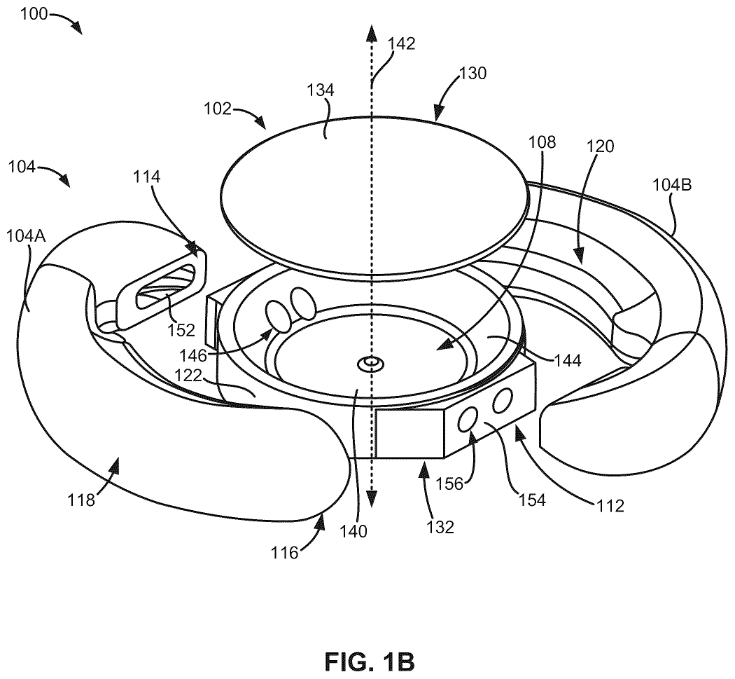

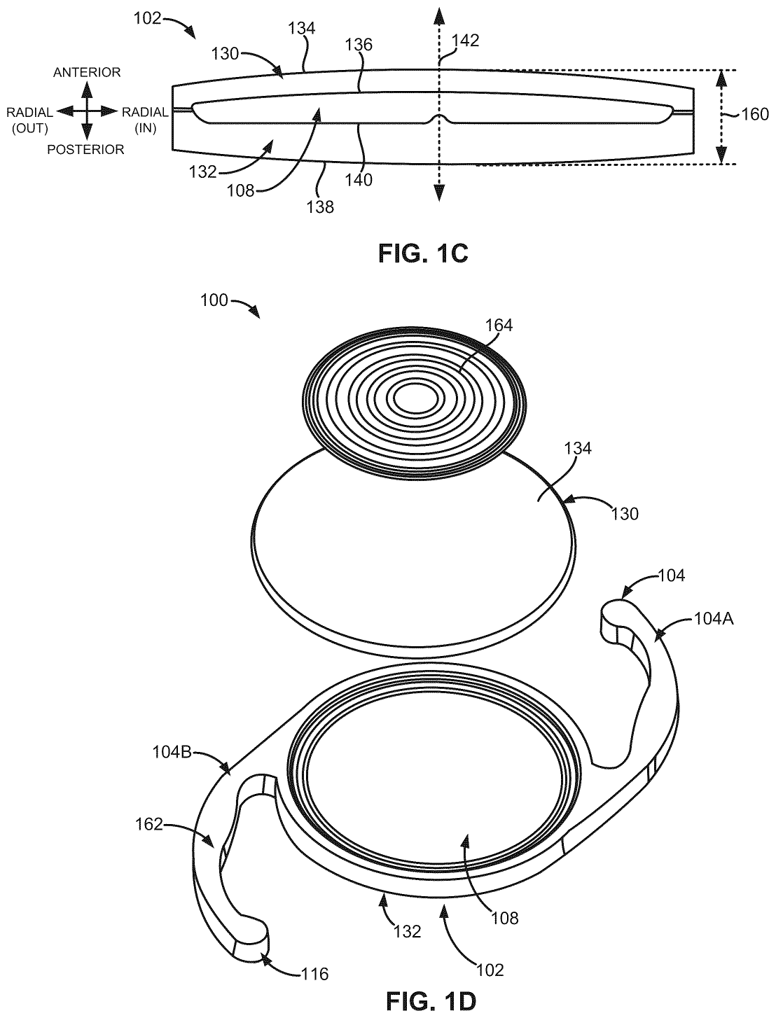

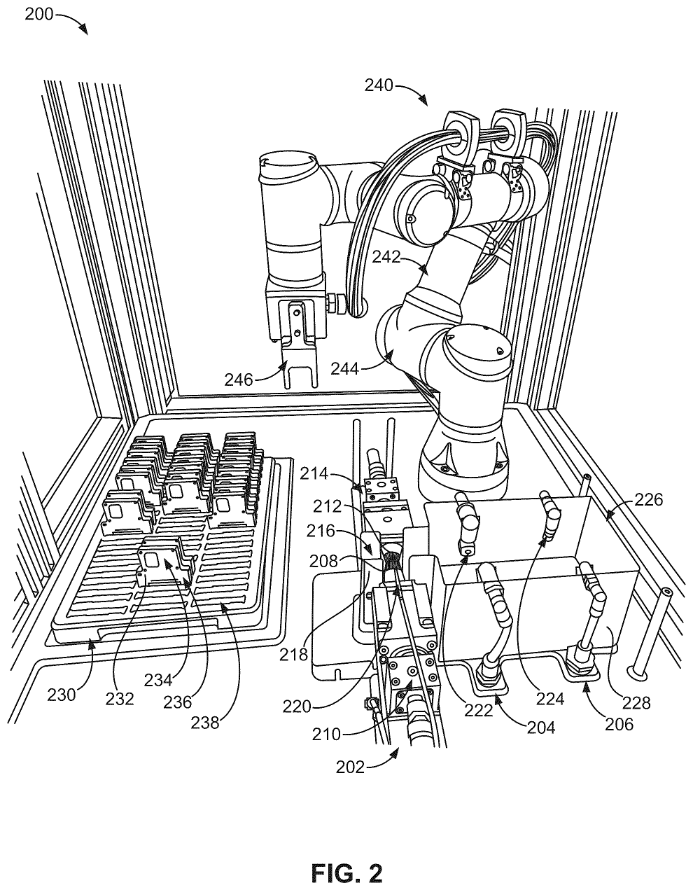

FIG. 1A illustrates a top plan view of one embodiment of an ophthalmic lens 100 that can be cleaned by the automated cleaning system 200 (see, e.g., FIG. 2) disclosed herein. In some embodiments, the ophthalmic lens 100 can be an IOL. The ophthalmic lens 100 can be implanted within a subject to correct for defocus aberration, corneal astigmatism, spherical aberration, or a combination thereof.

The ophthalmic lens 100 (e.g., an IOL) can comprise an optic portion 102 and one or more haptics 104 including a first haptic 104A and a second haptic 104B coupled to and extending peripherally from the optic portion 102. For example, the ophthalmic lens 100 can be positioned within a native capsular bag in which a native lens has been removed.

In some embodiments, the haptics 104 can be coupled to and adhered to the optic portion 102. For example, the haptics 104 can be adhered to the optic portion 102 after each is formed separately. In other embodiments, the ophthalmic lens 100 can be a one-piece lens such that the haptics 104 are connected to and extend from the optic portion 102. In this example embodiment, the haptics 104 are formed along with the optic portion 102 and are not adhered or otherwise coupled to the optic portion 102 in a subsequent step.

The ophthalmic lens 100 can have an uncompressed haptic length as measured from a haptic distal end of the first haptic 104A to the haptic distal end of the second haptic 104B. The uncompressed haptic length can be between about 8.0 mm and about 14.0 mm. For example, the uncompressed haptic length can be about 10.0 mm.

In some embodiments, the optic portion 102 of the ophthalmic lens 100 can have an optic portion diameter. The optic portion diameter can be between about 4.0 mm and 8.0 mm. For example, the optic portion diameter can be about 6.0 mm.

The ophthalmic lens 100 can be implanted within a native capsular bag of a subject after the subject's native lens has been removed. When implanted within the native capsular bag, the optic portion 102 can be adapted to refract light that enters the eye onto the retina.

In some embodiments, the ophthalmic lens 100 can be an accommodating IOL (or “AIOL”). When the ophthalmic lens 100 is an AIOL, one or more haptics 104 can be configured to engage the capsular bag and be adapted to deform in response to ciliary muscle movement (e.g., muscle relaxation, muscle contraction, or a combination thereof) in connection with capsular bag reshaping.

When the ophthalmic lens 100 is an AIOL, each of the haptics 104 can comprise a haptic fluid lumen 106 (shown in broken or phantom lines) extending through at least part of the haptic 104. For example, the first haptic 104A can comprise a first haptic fluid lumen 106A extending through at least part of the first haptic 104A and the second haptic 104B can comprise a second haptic fluid lumen 106B extending through at least part of the second haptic 104B. The haptic fluid lumen 106 (e.g., any of the first haptic fluid lumen 106A or the second haptic fluid lumen 106B) can be in fluid communication with or fluidly connected to an optic fluid chamber 108 within the optic portion 102.

The optic fluid chamber 108 and the haptic fluid lumen(s) 106 can comprise a fluid. A base power of the optic portion 102 can be configured to change based on an internal fluid pressure within the fluid-filled optic fluid chamber 108. The base power of the optic portion 102 can be configured to increase or decrease as fluid enters or exits the fluid-filled optic fluid chamber 108. For example, the base power of the optic portion 102 can be configured to decrease as fluid exits or is drawn out of the fluid-filled optic fluid chamber 108 into the haptic fluid lumen(s) 106. Also, for example, the base power of the optic portion 102 can be configured to increase as fluid enters the fluid-filled optic fluid chamber 108 from the haptic fluid lumen(s) 106.

The optic fluid chamber 108 can be in fluid communication with the one or more haptic fluid lumens 106 through one or more fluid channels 110. The fluid channels 110 can be conduits or passageways fluidly connecting the optic fluid chamber 108 to the haptic fluid lumens 106. The fluid channels 110 can be spaced apart from one another. For example, a pair of fluid channels 110 can be spaced apart between about 0.1 mm to about 1.0 mm. In some embodiments, each of the fluid channels 110 can have a diameter of between about 0.4 mm to about 0.6 mm.

The haptics 104 can be coupled to the optic portion 102 at a reinforced portion 112. The reinforced portion 112 can serve as a haptic-optic interface. The pair of fluid channels 110 can be defined or formed within part of the reinforced portion 112.

As shown in FIG. 1A, the optic fluid chamber 108 can be in fluid communication with the first haptic fluid lumen 106A through a first pair of fluid channels 110A. The optic fluid chamber 108 can also be in fluid communication with the second haptic fluid lumen 106B through a second pair of fluid channels 110B.

In some embodiments, the first pair of fluid channels 110A and the second pair of fluid channels 110B can be positioned substantially on opposite sides of the optic portion 102. The first pair of fluid channels 110A can be positioned substantially diametrically opposed to the second pair of fluid channels 110B. The first pair of fluid channels 110A and the second pair of fluid channels 110B can extend or be defined through part of the optic portion 102. The first pair of fluid channels 110A and the second pair of fluid channels 110B can extend or be defined through a posterior element 132 of the optic portion 102 (see, e.g., FIG. 1B).

FIG. 1A also illustrates that each of the haptics 104 (e.g., any of the first haptic 104A or the second haptic 104B) can have a proximal attachment end 114 and a distal free end 116. A haptic fluid port 152 (see, e.g., FIG. 1B) can be defined at the proximal attachment end 114 of the haptic 104. The haptic fluid port 152 can serve as an opening of the haptic fluid lumen 106. Fluid within the haptic fluid lumen 106 can flow out of the haptic fluid lumen 106 through the haptic fluid port 152 and into the optic fluid chamber 108 via the fluid channels 110 when the haptic 104 is coupled to the optic portion 102. Similarly, fluid within the optic fluid chamber 108 can flow out of the optic fluid chamber 108 through the pair of fluid channels 110 and into the haptic fluid lumen 106 through the haptic fluid port 152.

Each of the haptics 104 can comprise a radially-outer haptic lumen wall 118 and a radially-inner haptic lumen wall 120. The radially-outer haptic lumen wall 118 (also referred to as a radially-outer lateral wall of the haptic 104) can be configured to face and contact an inner surface of a patient's capsular bag when the ophthalmic lens 100 is implanted within the capsular bag. The radially-inner haptic lumen wall 120 (also referred to as a radially-inner lateral wall of the haptic 104) can be configured to face an outer peripheral surface 122 of the optic portion 102.

As previously discussed, the ophthalmic lens 100 can be implanted or introduced into a patient's capsular bag after a native lens has been removed from the capsular bag. The patient's capsular bag is connected to zonule fibers which are connected to the patient's ciliary muscles. The capsular bag is elastic and ciliary muscle movements can reshape the capsular bag via the zonule fibers. For example, when the ciliary muscles relax, the zonules are stretched. This stretching pulls the capsular bag in the generally radially outward direction due to radially outward forces. This pulling of the capsular bag causes the capsular bag to elongate, creating room within the capsular bag. When the patient's native lens is present in the capsular bag, the native lens normally becomes flatter (in the anterior-to-posterior direction), which reduces the power of the lens, allowing for distance vision. In this configuration, the patient's native lens is said to be in a disaccommodated state or undergoing disaccommodation.

When the ciliary muscles contract, however, as occurs when the eye is attempting to focus on near objects, the radially inner portion of the muscles move radially inward, causing the zonules to slacken. The slack in the zonules allows the elastic capsular bag to contract and exert radially inward forces on a lens within the capsular bag. When the patient's native lens is present in the capsular bag, the native lens normally becomes more curved (e.g., the anterior part of the lens becomes more curved), which gives the lens more power, allowing the eye to focus on near objects. In this configuration, the patient's native lens is said to be in an accommodated state or undergoing accommodation.

In embodiments where the ophthalmic lens 100 is an AIOL, the radially-outer haptic lumen wall 118 of the implanted AIOL can directly engage with or be in physical contact with the portion of the capsular bag that is connected to the zonules or zonule fibers. Therefore, the radially-outer haptic lumen wall 118 of the AIOL can be configured to respond to capsular bag reshaping forces that are applied radially when the zonules relax and stretch as a result of ciliary muscle movements.

For example, when the ciliary muscles contract, the peripheral region of the elastic capsular bag reshapes and applies radially inward forces on the radially-outer haptic lumen wall 118 of each of the haptics 104. When the ophthalmic lens 100 is an AIOL, the radially-outer haptic lumen wall 118 can deform or otherwise change shape and this deformation or shape-change can cause the volume of the haptic fluid lumen 106 to decrease. When the volume of the haptic fluid lumen 106 decreases, the fluid within the haptic fluid lumen 106 is moved or pushed into the optic fluid chamber 108. The optic portion 102 of the AIOL can change shape in response to fluid entering the optic fluid chamber 108 from the haptic fluid lumen 106. This can increase the base power or base spherical power of the AIOL and allow a patient with the AIOL implanted within the eye of the patient to focus on near objects. In this state, the adjustable AIOL can be considered to have undergone accommodation.

When the ciliary muscles relax, the peripheral region of the elastic capsular bag is stretched radially outward and the capsular bag elongates and more room is created within the capsular bag. The radially-outer haptic lumen wall 118 of the haptics 104 can be configured to respond to this capsular bag reshaping by returning to its non-deformed or non-stressed configuration. This causes the volume of the haptic fluid lumen 106 to increase or return to its non-deformed volume. This increase in the volume of the haptic fluid lumen 106 can cause the fluid within the optic fluid chamber 108 to be drawn out or otherwise flow out of the optic fluid chamber 108 and back into the haptic fluid lumen 106. Fluid moves out of the optic fluid chamber 108 into the haptic fluid lumen 106 through the same fluid channels 110 formed within the optic portion 102.

The optic portion 102 of the AIOL can change shape in response to fluid exiting the optic fluid chamber 108 and into the haptic fluid lumen 106. This can decrease the base power or base spherical power of the AIOL and allow a patient with the AIOL implanted within the eye of the patient to focus on distant objects or provide for distance vision. In this state, the AIOL can be considered to have undergone disaccommodation.

When the ophthalmic lens 100 is an AIOL, the radially-outer haptic lumen walls 118 of the haptics 104 can be made thinner than the radially-inner haptic lumen walls 120 to allow the haptics 104 to maintain a high degree of sensitivity to radial forces applied to an equatorial region of the haptics 104 by capsular bag reshaping as a result of ciliary muscle movements. The radially-inner haptic lumen walls 120 of the haptics 104 can be designed to be thicker or bulkier than the radially-outer haptic lumen walls 118 to provide the haptics 104 with stiffness or resiliency in the anterior-to-posterior direction. In certain embodiments, the radially-inner haptic lumen wall 120 can taper in shape as the radially-inner haptic lumen wall 120 gets closer to the optic portion 102. When designed in this manner, the haptics 104 can be less sensitive to capsular bag forces applied in the anterior-to-posterior direction. For example, when capsular bag forces are applied to the haptics 104 in the anterior-to-posterior direction, less fluid movement occurs between the haptic fluid lumens 106 and the optic fluid chamber 108 than when forces are applied in the radial direction. Since less fluid movement occurs, less changes in the base power of the AIOL occur.

Examples of AIOLs are discussed in the following U.S. patent publications: U.S. Pat. Pub. No. 2021/0100652; U.S. Pat. Pub. No. 2021/0100650; U.S. Pat. Pub. No. 2020/0337833; U.S. Pat. Pub. No. 2018/0256315; U.S. Pat. Pub. No. 2018/0153682; and U.S. Pat. Pub. No. 2017/0049561 and in the following issued U.S. patents: U.S. Pat. No. 10,299,913; U.S. Pat. No. 10,195,020; and U.S. Pat. No. 8,968,396, the contents of which are incorporated herein by reference in their entireties. In other embodiments, the ophthalmic lens 100 can also be a non-accommodating IOL. In further embodiments, the ophthalmic lens 100 can be a non-accommodating static-focus adjustable IOL. Examples of non-accommodating static-focus adjustable IOLs are discussed in U.S. Pat. Pub. No. 2021/0100649, the content of which is incorporated herein by reference in its entirety.

In some embodiments, the ophthalmic lens 100 can be designed such that a gap 124 or void space radially separates the radially-inner haptic lumen wall 120 of the haptic 104 from the outer peripheral surface 122 of the optic portion 102.

In some embodiments, the fluid within the optic fluid chamber 108 and the haptic fluid lumen(s) 106 can be an oil. More specifically, in certain embodiments, the fluid within the optic fluid chamber 108 and the haptic fluid lumen(s) 106 can be a silicone oil or fluid. For example, the fluid can be a silicone oil made in part of a diphenyl siloxane. In other embodiments, the fluid can be a silicone oil made in part of a ratio of two dimethyl siloxane units to one diphenyl siloxane unit. More specifically, in some embodiments, the fluid can be a silicone oil made in part of diphenyltetramethyl cyclotrisiloxane or a copolymer of diphenyl siloxane and dimethyl siloxane. In further embodiments, the fluid can be a silicone oil comprising branched polymers.

The fluid (e.g., the silicone oil) can be index matched with a lens body material used to make the optic portion 102. When the fluid is index matched with the lens body material, the entire optic portion 102 containing the fluid can act as a single lens. For example, the fluid can be selected so that it has a refractive index of between about 1.48 and 1.53 (or between about 1.50 and 1.53). In some embodiments, the fluid (e.g., the silicone oil) can have a polydispersity index of between about 1.2 and 1.3. In other embodiments, the fluid (e.g., the silicone oil) can have a polydispersity index of between about 1.3 and 1.5. In other embodiments, the fluid (e.g., the silicone oil) can have a polydispersity index of between about 1.1 and 1.2. Other example fluids are described in U.S. Patent Publication No. 2018/0153682, which is herein incorporated by reference in its entirety.

FIG. 1B illustrates an exploded view of the ophthalmic lens 100. The optic portion 102 of the ophthalmic lens 100 can comprise an anterior element 130 and a posterior element 132. A fluid-filled optic fluid chamber 108 can be defined in between the anterior element 130 and the posterior element 132.

The anterior element 130 can comprise an anterior optical surface 134 and an anterior inner surface 136 (see, e.g., FIG. 1C) opposite the anterior optical surface 134. The posterior element 132 can comprise a posterior optical surface 138 (see, e.g., FIG. 1C) and a posterior inner surface 140 opposite the posterior optical surface 138. Any of the anterior optical surface 134, the posterior optical surface 138, or a combination thereof can be considered and referred to as an external optical surface. The anterior inner surface 136 and the posterior inner surface 140 can face the optic fluid chamber 108. At least part of the anterior inner surface 136 and at least part of the posterior inner surface 140 can serve as chamber walls of the optic fluid chamber 108.

As shown in FIGS. 1B and 1C, the optic portion 102 can have an optical axis 142 extending in an anterior-to-posterior direction through a center of the optic portion 102. The optical axis 142 can extend through the centers of both the anterior element 130 and the posterior element 132.

The thickness of the anterior element 130 can be greater at or near the optical axis 142 than at the periphery of the anterior element 130. In some embodiments, the thickness of the anterior element 130 can increase gradually from the periphery of the anterior element 130 toward the optical axis 142.

In certain embodiments, the thickness of the anterior element 130 at or near the optical axis 142 can be between about 0.45 mm and about 0.55 mm. In these and other embodiments, the thickness of the anterior element 130 near the periphery can be between about 0.20 mm and about 0.40 mm. Moreover, the anterior inner surface 136 of the anterior element 130 can have less curvature or be flatter than the anterior optical surface 134.

The thickness of the posterior element 132 can be greater at or near the optical axis 142 than portions of the posterior element 132 radially outward from the optical axis 142 but prior to reaching a raised periphery 144 of the posterior element 132. The thickness of the posterior element 132 can gradually decrease from the optical axis 142 to portions radially outward from the optical axis 142 (but prior to reaching the raised periphery 144). As shown in FIGS. 1B and 1C, the thickness of the posterior element 132 can increase once again from a radially inner portion of the raised periphery 144 to a radially outer portion of the raised periphery 144.

In certain embodiments, the thickness of the posterior element 132 at or near the optical axis 142 can be between about 0.45 mm and about 0.55 mm. In these and other embodiments, the thickness of the posterior element 132 radially outward from the optical axis 142 (but prior to reaching the raised periphery 144) can be between about 0.20 mm and about 0.40 mm. The thickness of the posterior element 132 near the radially outer portion of the raised periphery 144 can be between about 1.00 mm and 1.15 mm. Moreover, the posterior inner surface 140 of the posterior element 132 can have less curvature or be flatter than the posterior optical surface 138.

FIG. 1B also illustrates that each of the haptics 104 (e.g., any of the first haptic 104A or the second haptic 104B) can have a proximal attachment end 114 and a closed distal free end 116. A haptic fluid port 152 can be defined at the proximal attachment end 114 of the haptic 104. The haptic fluid port 152 can serve as a chamber opening of the haptic fluid lumen 106. Fluid within the haptic fluid lumen 106 can flow out of the haptic fluid lumen 106 through the haptic fluid port 152 and into the optic fluid chamber 108 via the pair of fluid channels 110 when the haptic 104 is coupled to the optic portion 102. Similarly, fluid within the optic fluid chamber 108 can flow out of the optic fluid chamber 108 through the pair of fluid channels 110 and into the haptic fluid lumen 106 through the haptic fluid port 152. A pair of outer apertures 156 and inner apertures 146 can serve as ends of the fluid channels 110.

As shown in FIG. 1B, each of the haptics 104 can be coupled to the optic portion 102 at a reinforced portion 112. More specifically, the proximal attachment end 114 can be coupled to the protruding outer surface 154 of the posterior element 132. The protruding outer surface 154 can also be referred to as a “landing” or “haptic attachment landing.” The protruding outer surface 154 can extend out radially from an outer peripheral surface 122 of the optic portion 102. For example, the protruding outer surface 154 can extend out radially from an outer peripheral surface 122 of the posterior element 132 of the optic portion 102. The protruding outer surface 154 can extend out radially from the outer peripheral surface 122 between about 10 microns and 1.0 mm or between about 10 microns and 500 microns.

The proximal attachment end 114 can have a substantially flat surface to adhere or otherwise couple to a substantially flat surface of the protruding outer surface 154. When the proximal attachment end 114 is coupled to the protruding outer surface 154, the haptic fluid port 152 can surround the outer apertures 156 of the fluid channels 110. The haptics 104 can be coupled or adhered to the optic portion 102 via biocompatible adhesives. In some embodiments, the adhesives can be the same adhesives used to couple or adhere the anterior element 130 to the posterior element 132.

FIG. 1C illustrates an optic portion 102 of the ophthalmic lens 100 with the haptic(s) 104 removed for ease of viewing. As shown in FIG. 1C, the optic portion 102 can have an optic portion thickness 160 as measured from an anterior-most point on the anterior optical surface 134 to a posterior-most point on the posterior optical surface 138.

In some embodiments, the optic portion thickness 160 can be between about 1.50 mm and about 3.00 mm (e.g., about 1.50 mm, about 1.75 mm, about 2.00 mm, about 2.25 mm, about 2.50 mm, about 2.75 mm, about 3.00 mm, and amounts in between).

In some embodiments, the optic portion 102 can have a diopter power of between 6 diopters and 30 diopters. In these embodiments, the optic portion thickness 160 can vary based on the dioptric power of the optic portion 102.

The automated cleaning system 200 disclosed herein can clean ophthalmic lenses 100 comprising optic portions 102 with optic portion thicknesses 160 between about 1.50 mm and about 3.00 mm (e.g., about 1.50 mm, about 1.75 mm, about 2.00 mm, about 2.25 mm, about 2.50 mm, about 2.75 mm, about 3.00 mm, and amounts in between).

The automated cleaning system 200 disclosed herein can also clean ophthalmic lenses 100 with dioptric powers ranging from about 6 diopters to about 30 diopters.

FIG. 1D illustrates an exploded perspective view of another embodiment of an ophthalmic lens 100. As depicted in FIG. 1D, the ophthalmic lens 100 can comprise an optic portion 102 and one or more haptics 104 extending from the optic portion 102.

The haptics 104 can comprise a first haptic 104A and a second haptic 104B extending peripherally from or coupled to the optic portion 102. Each of the haptics 104 can comprise a kink 162 or bend defined along an arm of the haptic 104. The kink 162 or bend can allow the haptic 104 to compress or flex. Each of the haptics 104 can terminate at a free or unconnected haptic distal end 116.

For example, the ophthalmic lens 100 can be a one-piece lens such that the haptics 104 are connected to and extend from the optic portion 102. In other embodiments, the haptics 104 are coupled to and adhered to the optic portion 102. For example, the haptics 104 can be adhered to the optic portion 102 after each is formed separately.

The optic portion 102 can comprise an anterior element 130, a posterior element 132, and an optic chamber 108 defined in between the anterior element 130 and the posterior element 132. The optic chamber 108 can be filled with a fluid.

In some embodiments, the fluid within the optic chamber 108 can be an oil. More specifically, in certain embodiments, the fluid within the optic chamber 108 can be a silicone oil.

FIG. 1D also illustrates that the anterior element 130 can comprise an anterior optical surface 134. The anterior optical surface 134 can comprise a unique lens surface profile 164 or pattern defined on the anterior optical surface 1346

In some embodiments, the lens surface profile 164 can comprise a central diffractive area or structure comprising a plurality of diffractive zones or steps. In these and other embodiments, the widths of the diffractive zones can decrease in a radially outward manner such that zone widths at a periphery of the lens are smaller than zone widths near a central portion of the lens.

In certain embodiments, the lens surface profile 164 can split light into multiple foci or focal points. In these embodiments, the ophthalmic lens 100 can be considered a multifocal IOL or an adjustable multifocal IOL.

In some embodiments, the lens surface profile 164 can be configured to split light into two focal points (e.g., allowing for near and distant vision). In these embodiments, the ophthalmic lens 100 can be considered a bifocal IOL or an adjustable bifocal IOL.

The lens surface profile 164 can also be configured to split light into three focal points (e.g., allowing for near, intermediate, and distant vision). In these embodiments, the ophthalmic lens 100 can be considered a trifocal IOL or an adjustable trifocal IOL.

In other embodiments not shown in FIG. 1D, the external optical surface can have a uniformly curved (e.g., a spherical) lens surface or an aspherical lens surface providing focusing power for a single distance. In these embodiments, the ophthalmic lens 100 can be considered a monofocal IOL or an adjustable monofocal IOL.

In additional embodiments not shown in FIG. 1D, the anterior optical surface 134 can have a lens surface profile or pattern configured to provide an extended depth of focus or a single elongated focal point. In these embodiments, the ophthalmic lens 100 can be considered an extended depth of focus (EDOF) IOL or an adjustable EDOF IOL.

Moreover, any of the monofocal IOLs, the multifocal IOLs, or the EDOF IOLs can comprise a toric lens profile.

The ophthalmic lens 100 can have an uncompressed haptic length as measured from a haptic distal end of the first haptic 104A to the haptic distal end of the second haptic 104B. The uncompressed haptic length can be between about 12.0 mm and about 14.0 mm. For example, the uncompressed haptic length can be about 13.0 mm.

In some embodiments, the optic portion 102 of the ophthalmic lens 100 can have an optic portion diameter. The optic portion diameter can be between about 5.0 mm and 8.0 mm. For example, the optic portion diameter can be about 6.0 mm.

In some embodiments, the ophthalmic lens 100 can be made of a lens material. In some embodiments, the lens material can be a soft polymeric material. For example, the lens material can be a hydrophobic acrylic material.

For example, the lens material can be made in part of a cross-linked copolymer comprising a copolymer blend. The copolymer blend can comprise an alkyl acrylate or methacrylate, a fluoro-alkyl (meth) acrylate, and a phenyl-alkyl acrylate. It is contemplated by this disclosure and it should be understood by one of ordinary skill in the art that these types of acrylic cross-linked copolymers can be generally copolymers of a plurality of acrylates, methacrylates, or a combination thereof and the term “acrylate” as used herein can be understood to mean acrylates, methacrylates, or a combination thereof interchangeably unless otherwise specified.

The cross-linked copolymer used to make the lens material can comprise an alkyl acrylate or methacrylate in the amount of about 3% to 20% (wt %), a fluoro-alkyl acrylate or fluoro-alkyl methacrylate in the amount of about 10% to 35% (wt %), and a phenyl-alkyl acrylate in the amount of about 50% to 80% (wt %). In some embodiments, the cross-linked copolymer can comprise or be made in part of an n-butyl acrylate as the alkyl acrylate, trifluoroethyl methacrylate as the fluoro-alkyl acrylate, and phenylethyl acrylate as the phenyl-alkyl acrylate. More specifically, the cross-linked copolymer used to make the lens material can comprise n-butyl acrylate in the amount of about 3% to 20% (wt %) (e.g., between about 12% to 16%), trifluoroethyl methacrylate in the amount of about 10% to 35% (wt %) (e.g., between about 17% to 25%), and phenylethyl acrylate in the amount of about 50% to 80% (wt %) (e.g., between about 64% to 67%).

The final composition of the cross-linked copolymer used to make the lens body material can also comprise a cross-linker or cross-linking agent, such as ethylene glycol dimethacrylate (EGDMA), and a hydroxyl-functional acrylic monomer (hydroxyethyl acrylate (HEA) or hydroxyethyl methacrylate (HEMA)). For example, the final composition of the cross-linked copolymer used to make the lens material can also comprise a cross-linker or cross-linking agent (e.g., EGDMA) in the amount of about 1.0%. The final composition of the cross-linked copolymer used to make the lens body material can also comprise an initiator or initiating agent (e.g., Perkadox 16, Darocur, etc.) and a UV absorber.

The haptic(s) 104 can comprise or be made in part of a haptic material. In some embodiments, the haptic material can be a soft polymeric material. For example, the haptic material can be a hydrophobic acrylic material.

For example, the haptic material can comprise or be made in part of a cross-linked copolymer comprising a copolymer blend. The copolymer blend can comprise an alkyl acrylate, a fluoro-alkyl acrylate, and a phenyl-alkyl acrylate. For example, the cross-linked copolymer used to make the haptic material can comprise an alkyl acrylate in the amount of about 10% to 25% (wt %), a fluoro-alkyl acrylate in the amount of about 10% to 35% (wt %), and a phenyl-alkyl acrylate in the amount of about 50% to 80% (wt %). In some embodiments, the cross-linked copolymer used to make the haptic material can comprise n-butyl acrylate in the amount of about 10% to 25% (wt %) (e.g., between about 19% to about 23%), trifluoroethyl methacrylate in the amount of about 10% to 35% (wt %) (e.g., between about 14% to about 18%), and phenylethyl acrylate in the amount of about 50% to 80% (wt %) (e.g., between about 58% to about 62%). The final composition of the cross-linked copolymer used to make the haptic material can also comprise a cross-linker or cross-linking agent, such as EGDMA, in the amount of about 1.0%. The final composition of the cross-linked copolymer used to make the haptic material can also comprise a number of photoinitiators or photoinitiating agents (e.g., camphorquinone, 1-phenyl-1,2-propanedione, 2-ethylhexyl-4-(dimenthylamino) benzoate, etc.).

In some embodiments, the refractive index of the lens material can be between about 1.48 and about 1.53. In certain embodiments, the refractive index of the lens material can be between about 1.50 and about 1.53 (e.g., about 1.5178).

In alternative embodiments, at least part of the haptic(s) 104 and/or the optic portion 102 (e.g., the anterior element 130 and/or the posterior element 132) can be made of a composite material. The composite material can comprise an energy-absorbing constituent and a plurality of expandable components. A base power of the optic portion can be configured to change in response to an external energy directed at the composite material. Depending on where the composite material is placed or positioned within the haptic(s) 104 or the optic portion 102, expansion of the composite material can either increase or decrease the volume of the optic fluid chamber 108 and change the fluid pressure within the optic fluid chamber 108. The optic portion 102 can be configured to deform, flex, or otherwise change shape in response to a change in the fluid pressure within the optic fluid chamber 108. The base power of the optic portion can be configured to change between about 0.05 D to about 3.0 D in total in response to pulses of the external energy (e.g., laser light) directed at the composite material.

FIG. 2 illustrates one embodiment of an automated cleaning system 200 for cleaning ophthalmic lenses including any of the ophthalmic lenses 100 disclosed herein. The system 200 can comprise a brushing assembly 202, a rinsing assembly 204, and a drying assembly 206.

The brushing assembly 202 can comprise a first brush head 208, a first vibrating motor assembly 210 coupled to the first brush head 208, a second brush head 212, and a second vibrating motor assembly 214 coupled to the second brush head 212.

The first brush head 208 can be disposed or positioned at a distal end of the first vibrating motor assembly 210 and the second brush head 212 can be disposed or positioned at a distal end of the second vibrating motor assembly 214. The first vibrating motor assembly 210 can be configured to vibrate the first brush head 208 and the second vibrating motor assembly 214 can be configured to vibrate the second brush head 212 in order to brush the ophthalmic lens 100.

As shown in FIG. 2, in some embodiments, the first brush head 208 can be oriented such that it faces or directly faces (or on a directly opposing side of) the second brush head 212. At least part of the first brush head 208 and at least part of the second brush head 212 can extend into a brushing bay 216. The brushing bay 216 can be at least partly formed or defined by a plurality of brushing bay walls 218 extending vertically upward from a floor or base platform of the cleaning system 200. The brushing bay 216 and the brushing bay walls 218 can protect the first vibrating motor assembly 210 and the second vibrating motor assembly 214 from splatter while the ophthalmic lens 100 is being cleaned within the brushing bay 216.

In some embodiments, the brushing bay walls 218 can be made in part of a metallic material such as stainless steel. In other embodiments, the brushing bay walls 218 can be made in part of a ceramic material, a polymeric material, or a combination thereof (in lieu of a metallic material or in combination with a metallic material).

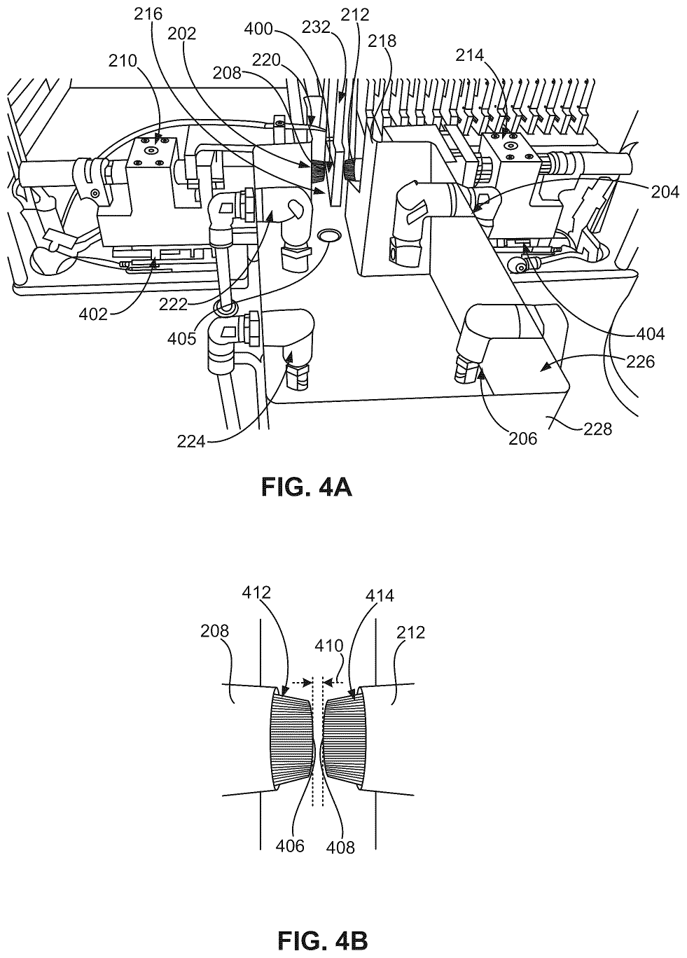

The first brush head 208 can be separated from the second brush head 212 by a lens receiving space 400 (see, e.g., FIG. 4A) prior to initiating the brushing step. When the ophthalmic lens 100 is positioned within the lens receiving space 400 in between the first brush head 208 and the second brush head 212, at least a part of the first brush head 208 and at least a part of the second brush head 212 can directly contact and brush the ophthalmic lens 100 as the brush heads vibrate.

The brushing assembly 202 can further comprise a surfactant drip 220 configured to drip or otherwise discharge a surfactant solution onto at least part of the ophthalmic lens 100 while the lens is being brushed by the first brush head 208 and the second brush head 212.

In some embodiments, the surfactant drip 220 can comprise a segment of tubing (e.g., silicone tubing) coupled to or in fluid communication with a liquid pump (e.g., a peristaltic liquid pump). In other embodiments, the surfactant drip 220 can comprise part of a syringe or conduit (e.g., polymeric or metallic conduit) coupled to or in fluid communication with a liquid pump.

As shown in FIG. 2, the surfactant drip 220 can be positioned or otherwise placed vertically above one of the brush heads and above one of the vibrating motor assemblies. A distal or terminal end of the surfactant drip 220 can allow a surfactant solution to drip or flow out of the open distal or terminal end of the surfactant drip 220 onto the ophthalmic lens 100 or any one of the brush heads.

Although FIG. 2 illustrates only one surfactant drip 220, it is contemplated by this disclosure that the system 200 can comprise two or more surfactant drips 220. For example, a first surfactant drip can be positioned above the first brush head 208 and a second surfactant drip can be positioned above the second brush head 212.

In some embodiments, the surfactant solution can be a nonionic surfactant solution. In certain embodiments, the surfactant solution can be a nonionic surfactant solution comprising polysorbate. For example, the surfactant solution can be polysorbate 20 (or Tween® 20).

As a more specific example, the surfactant solution can be a 0.5% (v/v) solution of polysorbate (e.g., polysorbate 20 or Tween® 20). Alternatively, the surfactant solution can be a 0.3%, 0.4%, 0.6%, 0.7%, 0.8%, 0.8% or 1.0% (v/v) solution of polysorbate.

In some embodiments, the surfactant solution is dripped or otherwise discharged onto the ophthalmic lens 100 or the one or more brush heads at a rate of between 3 mL and 7 mL per minute. For example, the surfactant solution can be dripped or otherwise discharged onto the ophthalmic lens 100 or the one or more brush heads at a rate of about 5 mL per minute. Also, for example, the surfactant solution can be dripped or otherwise discharged onto the ophthalmic lens 100 or the one or more brush heads at a rate of about 3 mL per minute, 4 mL per minute, 6 mL per minute, or 7 mL per minute.

The brushing assembly 202 can further comprise a first electric sliding actuator 402 (see, e.g., FIG. 4A) and a second electric sliding actuator 404. The first electric sliding actuator 402 can be configured to translate or physically move the first brush head 208 toward the second brush head 212 and the second electric sliding actuator 404 can be configured to translate or physically move the second brush head 212 toward the first brush head 208.

As will be shown in more detail in FIG. 4B, the first brush head 208 can comprise a first brush head distal end 406 (see, e.g., FIG. 4B) and the second brush head 212 can comprise a second brush head distal end 408. The first electric sliding actuator 402 and the second electric sliding actuator 404 can be configured to translate the brush heads toward one another until a brush gap 410 separates the first brush head distal end 406 from the second brush head distal end 408.

The first vibrating motor assembly 210 can cause the first brush head 208 to vibrate and the second vibrating motor assembly 214 can cause the second brush head 212 to vibrate when the first brush head distal end 406 and the second brush head 212 are separated by the brush gap 410 and at least part of the ophthalmic lens 100 is positioned within the brush gap 410.

In some embodiments, the brushing assembly 202 (the first brush head 208 and the second brush head 212) can brush the ophthalmic lens 100 for between about 60 seconds and 120 seconds. In other embodiments, the brushing assembly 202 (the first brush head 208 and the second brush head 212) can brush the ophthalmic lens 100 for between about 120 seconds and 200 seconds. In further embodiments, the brushing assembly 202 (the first brush head 208 and the second brush head 212) can brush the ophthalmic lens 100 for between about 20 seconds and 60 seconds.

FIG. 2 illustrates that the automated system 200 can further comprise the rinsing assembly 204 and the drying assembly 206. In some embodiments, the rinsing assembly 204 can be positioned or arranged next to or adjacent to the brushing assembly 202. In these embodiments, the drying assembly 206 can be positioned or arranged next to or adjacent to the rinsing assembly 204. As shown in FIG. 2, the brushing assembly 202, the rinsing assembly 204, and the drying assembly 206 can be arranged in a row such that an ophthalmic lens 100 can first be brushed by the brushing assembly 202, then be rinsed by the rinsing assembly 204, and then be dried by the drying assembly 206.

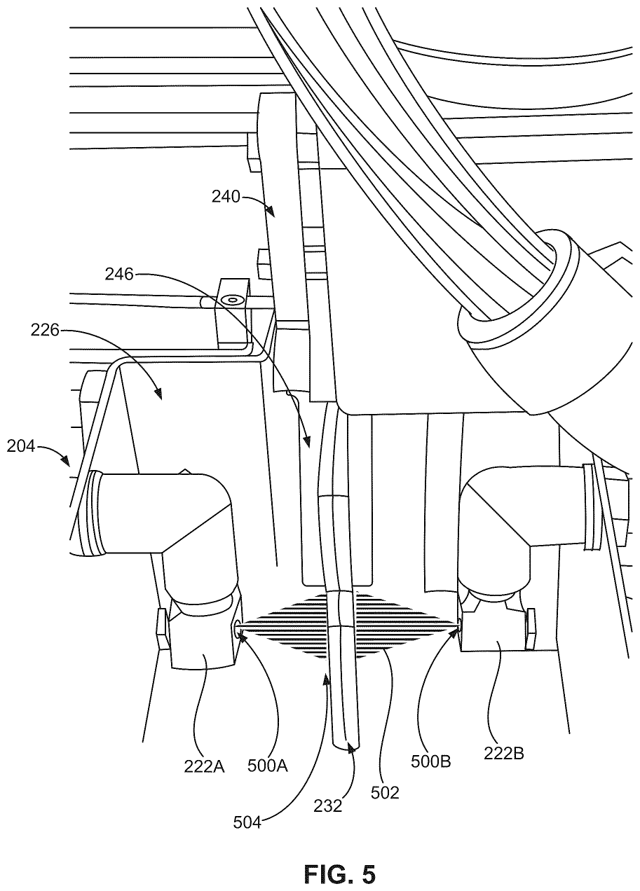

The rinsing assembly 204 can comprise at least one rinse nozzle 222. For example, the rinsing assembly 204 can comprise a first rinse nozzle 222A and a second rinse nozzle 222B (see, e.g., FIG. 5). The at least one rinse nozzle 222 of the rinsing assembly 204 can be configured to spray the ophthalmic lens 100 with a rinsing liquid after the ophthalmic lens 100 is brushed by the brushing assembly 202.

In some embodiments, the rinsing assembly 204 can rinse or spray the ophthalmic lens 100 for between about 60 seconds and 120 seconds. In other embodiments, the rinsing assembly 204 can rinse or spray the ophthalmic lens 100 for between about 120 seconds and 200 seconds. In further embodiments, the rinsing assembly 204 can rinse or spray the ophthalmic lens 100 for between about 20 seconds and 60 seconds.

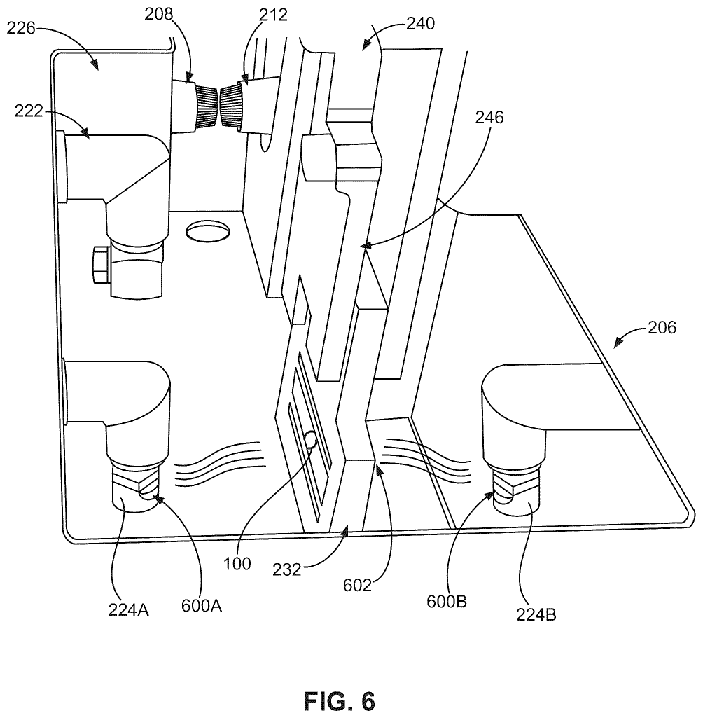

The drying assembly 206 can comprise at least one air dry nozzle 224. For example, the drying assembly 206 can comprise a first air dry nozzle 224A and a second air dry nozzle 224B (see, e.g., FIG. 4A and 6). The at least one air dry nozzle 224 of the drying assembly 206 can be configured to blow dry the ophthalmic lens 100 after the ophthalmic lens 100 is sprayed by the rinsing assembly 204.

In some embodiments, the drying assembly 206 can blow dry the ophthalmic lens 100 for between about 60 seconds and 120 seconds. In other embodiments, the drying assembly 206 can blow dry the ophthalmic lens 100 for between about 120 seconds and 200 seconds. In further embodiments, the drying assembly 206 can blow dry the ophthalmic lens 100 for between about 20 seconds and 60 seconds.

FIG. 2 illustrates that parts of the rinsing assembly 204 and drying assembly 206 can extend into a cleaning bay 226. For example, the at least one rinse nozzle 222 and the at least one air dry nozzle 224 can extend partly into the cleaning bay 226.

The cleaning bay 226 can be at least partly formed or defined by a plurality of cleaning bay walls 228 extending vertically upward from a floor or base platform of the cleaning system 200. For example, the cleaning bay 226 can comprise four cleaning bay walls 228 and be shaped substantially as a rectangular trough.

In some embodiments, the cleaning bay 226 can be connected to the brushing bay 216 such that an ophthalmic lens 100 can be easily transported from the brushing bay 216 into the cleaning bay 226 to be rinsed and dried. The cleaning bay 226 can also comprise one or more drains 405 (see, e.g., FIG. 4A) for draining the rinsing liquid.

FIG. 2 also illustrates that the cleaning system 200 can comprise a lens carrier tray 230 configured to hold a plurality of lens carriers 232. Each of the lens carriers 232 can be configured to hold the ophthalmic lens 100 in position while the ophthalmic lens 100 is being cleaned by the brushing assembly 202, the rinsing assembly 204, and the drying assembly 206.

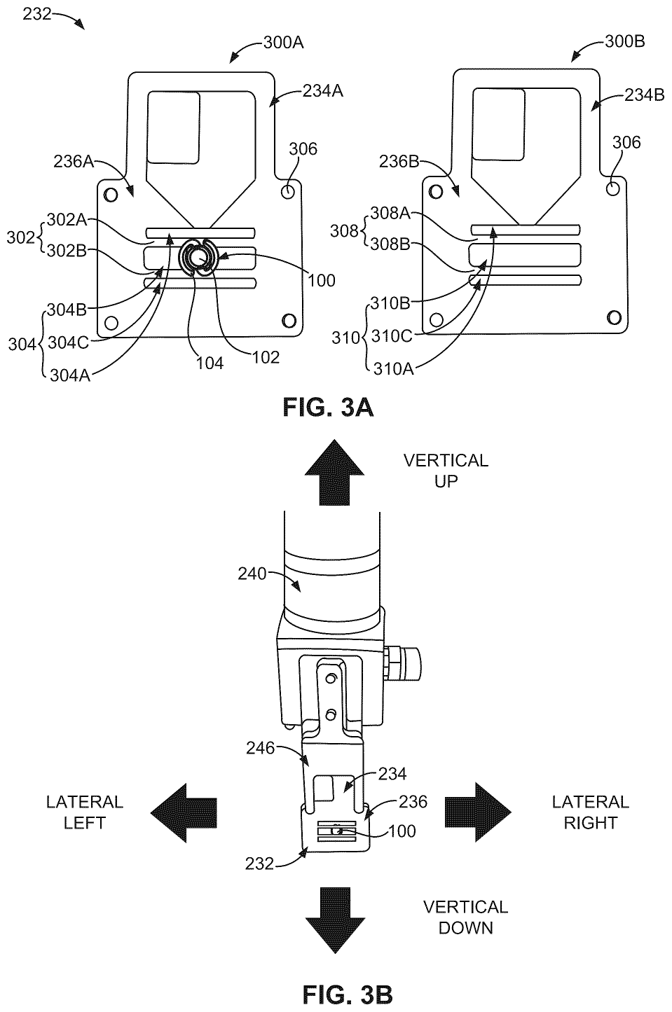

As will be discussed in more detail in relation to FIG. 3A, each of the lens carriers 232 can comprise a first carrier part 300A and a second carrier part 300B detachably coupled to the first carrier part 300A. The ophthalmic lens 100 can be sandwiched or otherwise positioned in between the first carrier part 300A and the second carrier part 300B when the second carrier part 300B is detachably coupled to the first carrier part 300A.

As shown in FIG. 2, each of the lens carriers 232 can comprise a handle region 234 and a holder region 236. In some embodiments, the handle region 234 can be positioned vertically above the holder region 236. The handle region 234 can be designed to be grasped in order to transport the lens carrier 232 and the ophthalmic lens 100.

The holder region 236 can be a part of the lens carrier 232 configured to hold or secure the ophthalmic lens 100. In some embodiments, the holder region 236 can be positioned vertically below the handle region 234. As will be discussed in more detail in relation to FIG. 3A, the lens carrier 232 can comprise a plurality of windows designed to expose the ophthalmic lens 100 for cleaning.

The portion of the holder region 236 holding the ophthalmic lens 100 can be inserted into a slot 238 defined along the lens carrier tray 230. This can protect the ophthalmic lens 100 from contamination or damage when the ophthalmic lens 100 is not being cleaned.

The lens carrier tray 230 and the lens carriers 232 can be made in part of a biocompatible material. In some embodiments, the lens carrier tray 230 and the lens carriers 232 can be made in part of a biocompatible polymeric material, a biocompatible metallic material, or a composite thereof. For example, at least one of the lens carrier tray 230 and the lens carriers 232 can be made in part of polycarbonate, polyethylene, polyvinyl chloride, polypropylene, polyether ether ketone, or a co-polymer thereof. Also, for example, at least one of the lens carrier tray 230 and the lens carriers 232 can be made in part of stainless steel.

FIG. 2 also illustrates that the cleaning system 200 can further comprise a robotic arm 240 configured to transport the lens carrier 232 holding the ophthalmic lens 100 to at least one of the brushing assembly 202, the rinsing assembly 204, and the drying assembly 206. The robotic arm 240 can comprise multiple serial linkages 242 connected by articulating joints 244. The robotic arm 240 can also comprise an end effector 246 for grasping the handle region 234 of the lens carrier 232.

In some embodiments, the robotic arm 240 can comprise six linkages 242 connected by six articulating joints 244 or axes. In these embodiments, the robotic arm 240 can have six degrees of freedom (6-DOF). For example, the robotic arm 240 can comprise an arm base, an arm shoulder, an arm elbow, and three articulating wrists. Each of the arm base, the arm shoulder, the arm elbow, and the three articulating wrists can have a working range of ±360 degrees.

For example, the robotic arm 240 can be a robotic arm distributed by Universal Robots A/S. As a more specific example, the robotic arm 240 can be any of the UR3e the UR5e, or the UR10e, model of robotic arms distributed by Universal Robots A/S.

The end effector 246 of the robotic arm 240 can grasp the handle region 234 of the lens carrier 232 and lift the lens carrier 232 out of the lens carrier tray 230. The robotic arm 240 can then transport or otherwise maneuver the lens carrier 232 to the brushing assembly 202 to brush the ophthalmic lens 100 carried by the lens carrier 232.

As will be discussed in more detail in relation to FIG. 3B, the robotic arm 240 can be configured to translate the lens carrier 232 laterally in a back-and-forth or left-to-right motion when the ophthalmic lens 100 is being brushed by the first brush head 208 and the second brush head 212. Moreover, the robotic arm 240 can be configured to translate the lens carrier 232 vertically in an up-and-down motion when the ophthalmic lens 100 is being sprayed or rinsed by the rinsing assembly 204. Furthermore, the robotic arm 240 can be configured to translate the lens carrier vertically in an up-and-down motion when the ophthalmic lens 100 is being blow dried by the drying assembly 206.

The movements of the robotic arm 240 and the operation of the brushing assembly 202, the rinsing assembly 204, and the drying assembly 206 can be controlled by a computing device or control unit in electrical communication with the robotic arm 240, the brushing assembly 202, the rinsing assembly 204, and the drying assembly 206. For example, one or more processors of the computing device or the control unit can be programmed to instruct the robotic arm 240 to pick up a lens carrier 232 from the lens carrier tray 230, transport or maneuver the lens carrier 232 to the brushing assembly 202, and to activate the brushing assembly 202 to brush the ophthalmic lens 100 carried by the lens carrier 232. The one or more processors of the computing device or the control unit can also instruct the robotic arm 240 to transport or move the lens carrier 232 to the rinsing assembly 204 after the ophthalmic lens 100 has been brushed by the brushing assembly 202 and to activate the rinsing assembly 204 to spray the ophthalmic lens 100 with a rinsing liquid. Once the ophthalmic lens 100 has been rinsed by the rinsing assembly 204, the one or more processors of the computing device or the control unit can instruct the robotic arm 240 to transport or move the lens carrier 232 to the drying assembly 206 and to activate the drying assembly 206 to blow dry the ophthalmic lens 100 with compressed air. Once the ophthalmic lens 100 has been dried by the drying assembly 206, the one or more processors of the computing device or the control unit can instruct the robotic arm 240 to transport or maneuver the lens carrier 232 back to the lens carrier tray 230 or to another lens carrier tray. The process can then be repeated with another lens carrier 232 from the lens carrier tray 230.

FIG. 3A illustrates one embodiment of a lens carrier 232 separated into a first carrier part 300A and a second carrier part 300B. In some embodiments, the lens carrier 232 can be configured as a cassette or cartridge comprising two cassette or cartridge parts (e.g., the first carrier part 300A and the second carrier part 300B).

As shown in FIG. 3A, the ophthalmic lens 100 can be configured to be positioned or otherwise placed on either the first carrier part 300A or the second carrier part 300B when the first carrier part 300A is detached from the second carrier part 300B. For example, this can be done prior to cleaning the ophthalmic lens 100 to prepare the ophthalmic lens 100 for cleaning.

FIG. 3A also illustrates that the first carrier part 300A can further comprise a first pair of securement bars 302 including a first top securement bar 302A and a first bottom securement bar 302B. The first top securement bar 302A can be positioned vertically above the first bottom securement bar 302B.

FIG. 3A further illustrates that a plurality of first windows 304 can be defined along the first carrier part 300A. The plurality of first windows 304 can comprise a first top window 304A, a first central window 304B, and a first bottom window 304C.

In some embodiments, the first top window 304A can be positioned above the first top securement bar 302A, the first central window 304B can separate the first top securement bar 302A from the first bottom securement bar 302B, and the first bottom window 304C can be positioned below the first bottom securement bar 302B.

The plurality of first windows 304 can be configured to expose the ophthalmic lens 100 during the cleaning process. The first windows 304 can be openings, slits, apertures, or slots defined along a body of the first carrier part 300A. As previously discussed, the lens carrier 232 in an assembled configured (where the first carrier part 300A is detachably coupled to the second carrier part 300B with the ophthalmic lens 100 secured in between) can have a handle region 234 and a holder region 236 immediately below the handle region 234 (see FIGS. 2 and FIG. 3B). The first carrier part 300A can comprise a first handle region 234A and a first holder region 236A. The plurality of first windows 304 and the first pair of securement bars 302 can be defined or disposed in the first holder region 236A of the first carrier part 300A.

As part of the process of preparing the ophthalmic lens 100 for cleaning, the ophthalmic lens 100 can be placed on the first carrier part 300A such that at least part of the one or more haptics 104 of the ophthalmic lens 100 are placed on or physically contacting the first pair of securement bars 302. For example, when the ophthalmic lens 100 comprises two haptics 104 (e.g., a first haptic 104A and a second haptic 104B, see FIG. 1B), the ophthalmic lens 100 can be placed on the first carrier part 300A such that proximal and distal ends of each of the haptics 104 is positioned on or physically contacting the first pair of securement bars 302. Additionally, the ophthalmic lens 100 can be placed on the first carrier part 300A such that the optic portion 102 of the ophthalmic lens 100 is positioned substantially in the center or midpoint of the first central window 304B. The ophthalmic lens 100 can be secured within the lens carrier 232 by detachably coupling the second carrier part 300B to the first carrier part 300A with the ophthalmic lens 100 located in between the first carrier part 300A and the second carrier part 300B.

FIG. 3A also illustrates that the first carrier part 300A and the second carrier part 300B can comprise a plurality of magnets 306 or magnetic couplers. In some embodiments, the first carrier part 300A can be detachably coupled to the second carrier part 300B via the plurality of magnets 306.

In other embodiments, the first carrier part 300A can be coupled to the second carrier part 300B by other detachable coupling mechanisms such as clasps, snap buttons, clips, screws, adhesives, or a combination thereof (with or without magnets).

FIG. 3A further illustrates that the second carrier part 300B can further comprise a second pair of securement bars 308 including a second top securement bar 308A and a second bottom securement bar 308B. The second top securement bar 308A can be positioned vertically above the second bottom securement bar 308B. The second pair of securement bars 308 can align with the first pair of securement bars 302 when the second carrier part 300B is detachably coupled to the first carrier part 300A (via magnets 306 or other mechanical couplers or fasteners).

FIG. 3A further illustrates that a plurality of second windows 310 can be defined along the second carrier part 300B. The plurality of second windows 310 can comprise a second top window 310A, a second central window 310B, and a second bottom window 310C.

In some embodiments, the second top window 310A can be positioned above the second top securement bar 308A, the second central window 310B can separate the second top securement bar 308A from the second bottom securement bar 308B, and the second bottom window 310C can be positioned below the second bottom securement bar 308B. The plurality of second windows 310 can align with the plurality of first windows 304 (e.g., the second top window 310A can align with the first top window 304A, the second central window 310B can align with the first central window 304B, and the second bottom window 310C can align with the first bottom window 304C) when the second carrier part 300B is detachably coupled to the first carrier part 300A (via magnets 306 or other mechanical couplers or fasteners).

The plurality of second windows 310 and the plurality of first windows 304 can be configured to expose the ophthalmic lens 100 during the cleaning process. The second windows 310 can be openings, slits, apertures, or slots defined along a body of the second carrier part 300B. As previously discussed, the lens carrier 232 in an assembled configured (where the second carrier part 300B is detachably coupled to the first carrier part 300A with the ophthalmic lens 100 secured in between) can have a handle region 234 and a holder region 236 immediately below the handle region 234 (see FIG. 2 and FIG. 3B). The second carrier part 300B can comprise a second handle region 234B and a second holder region 236B. The plurality of second windows 310 and the second pair of securement bars 308 can be defined or disposed in the second holder region 236B of the second carrier part 300B.

As part of the process of preparing the ophthalmic lens 100 for cleaning, once the ophthalmic lens 100 is placed on the first carrier part 300A such that at least part of the one or more haptics 104 of the ophthalmic lens 100 are placed on or physically contacting the first pair of securement bars 302, the second pair of securement bars 308 of the second carrier part 300B can be lined up or otherwise aligned with the first pair of securement bars 302 of the first carrier part 300A and the plurality of second windows 310 can be lined up or otherwise aligned with the plurality of first windows 304. At this point, the second carrier part 300B can be pressed onto or pressed against the first carrier part 300A to detachably couple the second carrier part 300B to the first carrier part 300A (via the magnets 306 or other mechanical couplers or fasteners). Once the second carrier part 300B is detachably coupled to the first carrier part 300A (via the magnets 306 or other mechanical couplers or fasteners), the ophthalmic lens 100 is now secured within the lens carrier 232 with the optic portion 102 and at least part(s) of the haptic(s) 104 of the ophthalmic lens 100 exposed by the plurality of first windows 304 and the plurality of second windows 310.

In some embodiments, the optic portion 102 and at least part(s) of the haptic(s) 104 of the ophthalmic lens 100 can be primarily exposed by the first central window 304A aligned with the second central window 310B. In these and other embodiments, other parts of the ophthalmic lens 100 can be exposed by the first top window 304A aligned with the second top window 310A, the first bottom window 304C aligned with the second bottom window 310C, or a combination thereof.

In certain embodiments, the plurality of first windows 304 can each have a first window length and the plurality of second windows 310 can each have a second window length. The first window length and the second window length can be greater than a diametric width of the optic portion 102 of the ophthalmic lens 100. In some embodiments, the first window length and the second window length can be greater than a diametric width of the optic portion 102 and a width of the haptic(s) 104 of the ophthalmic lens 100.

As shown in FIG. 3A, the plurality of first windows 304 and the plurality of second windows 310 can each be shaped as an elongate slot or elongate opening. This can allow the lens carrier 232 to be translated laterally back-and-forth (e.g., left-to-right, right-to-left, or a combination thereof) during the brushing process.

FIG. 3B illustrates one embodiment of the robotic end effector 246 of the robotic arm 240 of the automated cleaning system 200 grasping a lens carrier 232 carrying an ophthalmic lens 100. As shown in FIG. 3B, the lens carrier 232 is in an assembled configuration with the first carrier part 300A detachably coupled to the second carrier part 300B (also see, e.g., FIG. 3A).

When the lens carrier 232 is in the assembled configuration, the ophthalmic lens 100 within the lens carrier 232 can be secured by the securement bars of the lens carrier 232 including the first pair of securement bars 302 and the second pair of securement bars 308 (also see, e.g., FIG. 3A). The lens carrier 232 can be configured to hold the ophthalmic lens 100 by the haptic(s) 104 of the ophthalmic lens 100.

Also, when the lens carrier 232 is in the assembled configuration, at least a part of the ophthalmic lens 100 within the lens carrier 232 (e.g., at least a part of the optic portion 102 and/or the haptic(s) 104) can be exposed by windows defined along the holder region 236 of the lens carrier 232. For example, at least a part of the ophthalmic lens 100 within the lens carrier 232 can be exposed by the plurality of first windows 304 of the first carrier part 300A aligned with the plurality of second windows 310 of the second carrier part 300B.

FIG. 3B also illustrates that the end effector 246 of the robotic arm 240 can grasp the handle region 234 of the lens carrier 23 to transport the lens carrier 232 holding the ophthalmic lens 100 to any one of the brushing assembly 202, the rinsing assembly 204, and the drying assembly 206 (see, e.g., FIG. 2).

In some embodiments, the end effector 246 can be a robotic gripper such as a pair of pneumatic grippers, hydraulic grippers, magnetic grippers, or servo-electric grippers. In certain embodiments, the end effector 246 can also be a claw-like gripper or finger-type soft gripper.

As shown in FIG. 3B, the robotic arm 240 can be configured to translate the lens carrier 232 laterally in a back-and-forth motion (e.g., a repeated right-to-left motion, a repeated left-to-right motion, or a combination thereof). For example, the robotic arm 240 can be configured to translate the lens carrier 232 in a lateral leftward motion, in a lateral rightward motion, or a combination thereof.

The robotic arm 240 can also be configured to translate the lens carrier vertically in an up-and-down motion. For example, the robotic arm 240 can be configured to translate the lens carrier 232 in a vertical upward motion, in a vertical downward motion, or a combination thereof.

The robotic arm 240 (including the end effector 246) can be configured to translate the lens carrier 232 laterally in a back-and-forth motion (e.g., a repeated right-to-left motion, a repeated left-to-right motion, or a combination thereof) when the ophthalmic lens 100 is being brushed by the first brush head 208 and the second brush head 212 of the brushing assembly 202 (see, e.g., FIG. 2)

In alternative embodiments, the robotic arm 240 (including the end effector 246) can also be configured to translate the lens carrier 232 vertically in an up-and-down motion or in a laterally back-and-forth motion in combination with a vertically up-and-down motion when the ophthalmic lens 100 is being brushed by the first brush head 208 and the second brush head 212 of the brushing assembly 202.

The robotic arm 240 (including the end effector 246) can be configured to translate the lens carrier 232 vertically in an up-and-down motion (repeatedly) when the ophthalmic lens 100 is being rinsed or sprayed by the at least one rinse nozzle 222 of the rinsing assembly 204 (see, e.g., FIG. 2)

In alternative embodiments, the robotic arm 240 (including the end effector 246) can also be configured to translate the lens carrier 232 laterally in a back-and-forth motion (e.g., a repeated right-to-left motion, a repeated left-to-right motion, or a combination thereof) or in a laterally back-and-forth motion in combination with a vertically up-and-down motion when the ophthalmic lens 100 is being rinsed or sprayed by the rinsing assembly 204 (see, e.g., FIG. 2).

The robotic arm 240 (including the end effector 246) can be configured to translate the lens carrier 232 vertically in an up-and-down motion (repeatedly) when the ophthalmic lens 100 is being blow dried by the at least one air dry nozzle 224 of the drying assembly 206 (see, e.g., FIG. 2).

In alternative embodiments, the robotic arm 240 (including the end effector 246) can also be configured to translate the lens carrier 232 laterally in a back-and-forth motion (e.g., a repeated right-to-left motion, a repeated left-to-right motion, or a combination thereof) or in a laterally back-and-forth motion in combination with a vertically up-and-down motion when the ophthalmic lens 100 is being blow dried by the drying assembly 206 (see, e.g., FIG. 2).

As previously discussed, the robotic arm 240 can be configured or controlled by a computing device or control unit to translate the lens carrier 232. For example, one or more processors of the computing device or the control unit can execute instructions stored in a memory unit or storage unit of the computing device or the control unit to control the robotic arm 240 to move the lens carrier 232 carrying the ophthalmic lens 100 in a desired manner.

FIG. 4A illustrates a lens carrier 232 positioned in between brushes (e.g., the first brush head 208 and the second brush head 212) of the brushing assembly 202. As shown in FIG. 4A, the first brush head 208 can be separated from the second brush head 212 by a lens receiving space 400. When the ophthalmic lens 100 is positioned within the lens receiving space 400 in between the first brush head 208 and the second brush head 212, at least part of each of the first brush head 208 and the second brush head 212 can directly contact and brush the ophthalmic lens 100 as the brush heads vibrate.

One technical problem faced by the applicants is how to design an automated system to clean ophthalmic lenses when such lenses are often made of extremely delicate and soft materials. One technical solution discovered and developed by the applicants is the automated system 200 disclosed herein where the ophthalmic lens 100 is carried by a two-part lens carrier 232 which is then maneuvered by a robotic arm 240 to a brushing assembly 202 to be brushed, a rinsing assembly 204 to be rinsed, and then to a drying assembly 206 to be blow dried. The automated system 200 disclosed herein cuts down on errors associated with manual cleaning procedures and ensures that all ophthalmic lenses 100 are cleaned in the same uniform manner.

The first brush head 208 can be coupled to a first vibrating motor assembly 210. The first vibrating motor assembly 210 can be configured to vibrate the first brush head 208.

In some embodiments, the first vibrating motor assembly 210 can be configured to vibrate the first brush head 208 at a sonic frequency. For example, the first vibrating motor assembly 210 can be configured to vibrate the first brush head 208 at a frequency of between 100 Hz and 600 Hz. Also, for example, the first vibrating motor assembly 210 can be configured to vibrate the first brush head 208 at a frequency of between 10 Hz and 100 Hz.

The second brush head 212 can be coupled to a second vibrating motor assembly 214. The second vibrating motor assembly 214 can be configured to vibrate the second brush head 212.

In some embodiments, the second vibrating motor assembly 214 can be configured to vibrate the second brush head 212 at a sonic frequency. For example, the second vibrating motor assembly 214 can be configured to vibrate the second brush head 212 at a frequency of between 100 Hz and 600 Hz. Also, for example, the second vibrating motor assembly 214 can be configured to vibrate the second brush head 212 at a frequency of between 10 Hz and 100 Hz.

In certain embodiments, at least one of the first vibrating motor assembly 210 and the second vibrating motor assembly 214 can comprise a sonic vibration motor. In other embodiments, at least one of the first vibrating motor assembly 210 and the second vibrating motor assembly 214 can comprise an encapsulated eccentric rotating mass (ERM) vibration motor.

In some embodiments, the lens carrier 232 can be translated by the robotic arm 240 (see, e.g., FIGS. 2 and 3B) in a lateral back-and-forth motion (e.g., a lateral left-to-right motion, a lateral right-to-left motion, or a combination thereof, repeatedly) while the ophthalmic lens 100 within the lens carrier 232 is being brushed by the vibrating brush heads (e.g., the first brush head 208 and the second brush head 212) of the brushing assembly 202. In these embodiments, the lens carrier 232 can be translated laterally by the robotic arm 240 for a total distance of between about 4.0 mm and 6.0 mm (e.g., about 3.0 mm to the left of center as the left-most point and about 3.0 mm to the right of center as the right-most point). The ophthalmic lens 100 can be brushed for between 60 seconds and 120 seconds. In other embodiments, the ophthalmic lens 100 can be brushed for between 20 seconds and 60 seconds or greater than 120 seconds.

In alternative embodiments, the lens carrier 232 can be translated by the robotic arm 240 (see, e.g., FIGS. 2 and 3B) in a lateral back-and-forth motion (e.g., a lateral left-to-right motion, a lateral right-to-left motion, or a combination thereof, repeatedly) while the ophthalmic lens 100 within the lens carrier 232 is being brushed by the first brush head 208 and the second brush head 212 without the brush heads being vibrated by the vibrating motor assemblies. In these embodiments, the lens carrier 232 can be translated laterally by the robotic arm 240 for a total distance of about 6.0 mm (e.g., about 3.0 mm to the left of center as the left-most point and about 3.0 mm to the right of center as the right-most point). The ophthalmic lens 100 can be brushed for between 60 seconds and 120 seconds. In other embodiments, the ophthalmic lens 100 can be brushed for between 20 seconds and 60 seconds or greater than 120 seconds.

FIG. 4A also illustrates that the brushing assembly 202 can further comprise a surfactant drip 220 configured to drip or otherwise discharge a surfactant solution onto at least part of the ophthalmic lens 100 or either of the brush heads (e.g., the first brush head 208 or the second brush head 212) while the ophthalmic lens 100 is being brushed by the first brush head 208 and the second brush head 212.

For example, the surfactant drip 220 can comprise a segment of tubing (e.g., silicone tubing) coupled to or in fluid communication with a liquid pump (e.g., a peristaltic liquid pump). In other embodiments, the surfactant drip 220 can comprise part of a syringe or conduit (e.g., polymeric or metallic conduit) coupled to or in fluid communication with a liquid pump.

As shown in FIG. 4A, the surfactant drip 220 can be positioned or otherwise placed vertically above one of the brush heads and above one of the vibrating motor assemblies. A distal or terminal end of the surfactant drip 220 can allow a surfactant solution to drip or flow out of the distal end or terminal end of the surfactant drip 220 onto the ophthalmic lens 100 or onto any one of the brush heads.

Although FIG. 2 illustrates only one surfactant drip 220, it is contemplated by this disclosure that the system 200 can comprise two or more surfactant drips 220. For example, a first surfactant drip can be positioned above the first brush head 208 and a second surfactant drip can be positioned above the second brush head 212.

In some embodiments, the surfactant solution can be a nonionic surfactant solution. In certain embodiments, the surfactant solution can be a nonionic surfactant solution comprising polysorbate. For example, the surfactant solution can be polysorbate 20 (or Tween® 20).

As a more specific example, the surfactant solution can be a 0.5% (v/v) solution of polysorbate (e.g., polysorbate 20 or Tween® 20). Alternatively, the surfactant solution can be a 0.3%, 0.4%, 0.6%, 0.7%, 0.8%, 0.8% or 1.0% (v/v) solution of polysorbate.

In some embodiments, the surfactant solution can be dripped or otherwise discharged onto the ophthalmic lens 100 or onto one or more brush heads (e.g., the first brush head 208, the second brush head 212, or a combination thereof) at a rate of between 3 mL and 7 mL per minute. For example, the surfactant solution can be dripped or otherwise discharged onto the ophthalmic lens 100 or onto one or more brush heads at a rate of about 5 mL per minute. Also, for example, the surfactant solution can be dripped or otherwise discharged onto the ophthalmic lens 100 or onto one or more brush heads at a rate of about 3 mL per minute, 4 mL per minute, 6 mL per minute, or 7 mL per minute.

One technical problem faced by the applicants is how best to deliver a surfactant solution to the ophthalmic lens 100 while the lens is being cleaned. One technical solution discovered and developed by the applicants is the unique setup of the surfactant drip 220 where a surfactant solution is dripped onto the ophthalmic lens 100 or the brush heads from above at a rate of between 3 mL and 7 mL per minute during the brushing procedure.

The brushing assembly 202 can further comprise a first electric sliding actuator 402, and a second electric sliding actuator 404. The first electric sliding actuator 402 can be configured to translate or physically move the first brush head 208 toward the second brush head 212 and the second electric sliding actuator 404 can be configured to translate or physically move the second brush head 212 toward the first brush head 208.

In some embodiments, the first electric sliding actuator 402 can be positioned below the first vibrating motor assembly 210 and the second electric sliding actuator 404 can be positioned below the second vibrating motor assembly 214.

In some embodiments, at least one of the first electric sliding actuator 402 and the second electric sliding actuator 404 can be a linear electric sliding table comprising a motor (e.g., an integrated stepper motor or high-speed servo motor), a driving mechanism (e.g., linear ball screw), an encoder (a battery-less absolute encoder), worktable, and a linear guide (e.g., a linear recirculating ball bearing guide).

The first electric sliding actuator 402, the second electric sliding actuator 404, the first vibrating motor assembly 210, and the second vibrating motor assembly 214 can be controlled by the computing device or control unit. For example, one or more processors of the computing device or control unit can execute instructions stored in a memory unit or storage unit of the computing device or the control unit to control the robotic arm 240 to activate the first electric sliding actuator 402, the second electric sliding actuator 404, the first vibrating motor assembly 210, and the second vibrating motor assembly 214. The first electric sliding actuator 402, the second electric sliding actuator 404, the first vibrating motor assembly 210, and the second vibrating motor assembly 214 can be activated when the robotic arm 240 (see, e.g., FIGS. 2 and 3B) has transported or otherwise maneuvered the lens carrier 232 to the lens receiving space 400 in between the first brush head 208 and the second brush head 212.

FIG. 4A also illustrates that the cleaning bay 226 can also comprise one or more drains 405 to drain the surfactant solution and the rinsing liquid.

FIG. 4B is a close-up view of one embodiment of the first brush head 208 and the second brush head 212 of the brushing assembly 202. As shown in FIG. 4B, the first brush head 208 can comprise a first brush head distal end 406 and the second brush head 212 can comprise a second brush head distal end 408. The first electric sliding actuator 402 and the second electric sliding actuator 404 can be configured to translate the brush heads toward one another until a brush gap 410 separates the first brush head distal end 406 and the second brush head distal end 408.

The first vibrating motor assembly 210 can cause the first brush head 208 to vibrate and the second vibrating motor assembly 214 can cause the second brush head 212 to vibrate when the first brush head distal end 406 and the second brush head 212 are separated by the brush gap 410 and at least part of the ophthalmic lens 100 is positioned within the brush gap 410.

FIG. 4B also illustrates that the first brush head 208 can comprise a plurality of first brush bristles 412 and the second brush head 212 can comprise a plurality of second brush bristles 414. The plurality of first brush bristles 412 and the plurality of second brush bristles 414 can be made of polymeric fibers.

In some embodiments, the plurality of first brush bristles 412 and the plurality of second brush bristles 414 can be made of polyethylene fibers. For example, the plurality of first brush bristles 412 and the plurality of second brush bristles 414 can be made of polyethylene terephthalate (PET) fibers. As a more specific example, the plurality of first brush bristles 412 and the plurality of second brush bristles 414 can be made of Dacron™

As shown in FIG. 4B, in some embodiments, the plurality of first brush bristles 412 can be arranged in a frustonical shape. In these and other embodiments, the plurality of second brush bristles 414 can be arranged in a frustonical shape.

In alternative embodiments, the plurality of first brush bristles 412 and the plurality of second brush bristles 414 can be arranged in a cylindrical or disk shape, a conical shape, a truncated pyramidal shape, a hemispherical shape, a cuboidal shape, or a combination thereof.

In some embodiments, the brushing assembly 202 (the first brush head 208 and the second brush head 212) can brush the ophthalmic lens 100 for between about 60 seconds and 120 seconds. In other embodiments, the brushing assembly 202 (the first brush head 208 and the second brush head 212) can brush the ophthalmic lens 100 for between about 120 seconds and 200 seconds. In further embodiments, the brushing assembly 202 (the first brush head 208 and the second brush head 212) can brush the ophthalmic lens 100 for between about 20 seconds and 60 seconds.

As previously discussed, the first electric sliding actuator 402 and the second electric sliding actuator 404 can be configured to translate the brush heads toward one another until a brush gap 410 separates the first brush head distal end 406 from the second brush head distal end 408. In some embodiments, the brush gap 410 can be between about 0.3 mm and 2.0 mm (e.g., about 0.3 mm, about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or about 2.0 mm).

In some embodiments, the brush gap 410 can be less than the optic portion thickness 160 (see, e.g., FIG. 1C) of the optic portion 102 of the ophthalmic lens 100.

In other embodiments, the brush gap 410 can be substantially equivalent to the optic portion thickness 160.

One technical problem faced by the applicants is how to design an automated brushing assembly that can thoroughly clean an ophthalmic lens 100 without damaging the optic portion of the ophthalmic lens 100. One technical solution discovered and developed by the applicants is the brushing assembly 202 disclosed herein where a robotic arm 240 holds a lens carrier 232 carrying the ophthalmic lens 100 in between two brush heads (the first brush head 208 and the second brush head 212) that come closer together when the lens carrier 232 is positioned in between the two brush heads. The brush heads can be separated by a brush gap 410 that is less than a thickness of the optic portion 102 of the ophthalmic lens 100. The brush heads (the first brush head 208 and the second brush head 212) are then vibrated by their respective vibrating motor assemblies at a frequency of between 100 Hz and 600 Hz. While the brush heads vibrate at this frequency, the lens carrier 232 is translated laterally by the robotic arm 240 in a back-and-forth motion (or left-to-right/right-to-left motion).

Another technical advantage of the automated brushing assembly 202 disclosed herein is the unique frustonical shape of the first brush bristles 412 of the first brush head 208 and the second brush bristles 414 of the second brush head 212. The brush bristles can be made of soft polymeric fibers such as polyethylene terephthalate (PET) fibers (e.g., Dacron™).

FIG. 5 illustrates one embodiment of a rinsing assembly 204 of the automated cleaning system 200. The rinsing assembly 204 can comprise a first rinse nozzle 222A comprising a first spray nozzle port 500A and a second rinse nozzle 222B comprising a second spray nozzle port 500B. At least part of the first rinse nozzle 222A and the second rinse nozzle 222B can be located within the cleaning bay 226.

As shown in FIG. 5, the first spray nozzle port 500A can directly face the second spray nozzle port 500B to spray the ophthalmic lens 100 with a rinsing liquid 502 from opposite sides. For example, the first spray nozzle port 500A can spray an anterior element 130 (see, e.g., FIG. 1B) of the ophthalmic lens 100 and the second spray nozzle port 500B can spray a posterior element 132 (see, e.g., FIG. 1B) of the ophthalmic lens 100.

In some embodiments, the rinsing liquid 502 can be deionized water. In other embodiments, the rinsing liquid 502 can comprise another type of rinsing solution.

FIG. 5 also illustrates that the ophthalmic lens 100 (hidden from view in FIG. 5) can be carried by the lens carrier 232 when being sprayed by the first rinse nozzle 222A and the second rinse nozzle 222B. As previously discussed, the lens carrier 232 can comprise a plurality of windows that expose the ophthalmic lens 100 while the ophthalmic lens 100 is carried by the lens carrier 232.

As shown in FIG. 5, the lens carrier 232 can be grasped or otherwise held by the end effector 246 of the robotic arm 240. In some embodiments, the robotic arm 240 can be configured or controlled by a computing device or control unit to translate the lens carrier 232 vertically in an up-and-down motion, repeatedly, when the ophthalmic lens 100 is being sprayed by the rinsing assembly 204.

In other embodiments, the robotic arm 240 can be configured or controlled by a computing device or control unit to translate the lens carrier 232 laterally in a back-and-forth or right-to-left motion, repeatedly, when the ophthalmic lens 100 is being sprayed by the rinsing assembly 204. In further embodiments, the robotic arm 240 can be configured or controlled by a computing device or control unit to translate the lens carrier 232 both vertically in an up-and-down motion and laterally in a back-and-forth or right-to-left motion, repeatedly, when the ophthalmic lens 100 is being sprayed by the rinsing assembly 204.

In some embodiments, the ophthalmic lens 100 can be rinsed by the rinsing assembly 204 for between 60 seconds and 200 seconds (e.g., about 120 seconds). In other embodiments, the ophthalmic lens 100 can be rinsed by the rinsing assembly 204 for less than 30 seconds, for between 30 seconds and 60 seconds, for between 200 seconds and 300 seconds, or for greater than 300 seconds.

The robotic arm 240 can transport or otherwise maneuver the lens carrier 232 to a space 504 in between the first rinse nozzle 222A and the second rinse nozzle 222B in order to rinse or spray the ophthalmic lens 100 carried by the lens carrier 232. The lens carrier 232 can be positioned substantially equidistant between the first spray nozzle port 500A and the second spray nozzle port 500B by the robotic arm 240 while the ophthalmic lens 100 is being rinsed/sprayed.

As previously discussed, one or more processors of a computing device or a control unit can execute instructions stored in a memory unit or storage unit of the computing device or the control unit to control the robotic arm 240 to move the lens carrier 232 carrying the ophthalmic lens 100 to the space 504 in between the first rinse nozzle 222A and the second rinse nozzle 222B and the one or more processors can also execute instructions to control the rinsing assembly 204 to rinse or spray the ophthalmic lens 100 with the rinsing liquid 502 while the lens carrier 232 is positioned within the space 504. In addition, the one or more processors can also execute instructions to control the robotic arm 240 to translate the lens carrier 232 vertically in an up-and-down motion (and/or laterally in a left-to-right motion), repeatedly, while the ophthalmic lens 100 is being rinsed or sprayed. The one or more processors can further execute instructions to move the lens carrier 232 to the drying assembly 206 once the ophthalmic lens 100 has been rinsed or sprayed for between about 60 seconds and 200 seconds.

FIG. 6 illustrates one embodiment of a drying assembly 206 of the automated cleaning system 200 blow drying an ophthalmic lens 100 carried by the lens carrier. The drying assembly 206 can comprise a first air dry nozzle 224A comprising a first air nozzle port 600A and a second air dry nozzle 224B comprising a second air nozzle port 600B. At least part of the first air dry nozzle 224A and the second air dry nozzle 224B can be located within the cleaning bay 226.

As shown in FIG. 6, the first air nozzle port 600A can directly face the second air nozzle port 600B to blow dry the ophthalmic lens 100 with compressed air from opposite sides. For example, the first air nozzle port 600A can blow dry an anterior element 130 (see, e.g., FIG. 1B) of the ophthalmic lens 100 and the second air nozzle port 600B can blow dry a posterior element 132 (see, e.g., FIG. 1B) of the ophthalmic lens 100.

In some embodiments, at least one of the first air dry nozzle 224A and the second air dry nozzle 224B can be an air knife designed to emit compressed air. In other embodiments, at least one of the first air dry nozzle 224A and the second air dry nozzle 224B can be a blower-powered air knife.

FIG. 6 also illustrates that the ophthalmic lens 100 can be carried by the lens carrier 232 when being blow dried by the first air dry nozzle 224A and the second air dry nozzle 224B. As previously discussed, the lens carrier 232 can comprise a plurality of windows that expose the ophthalmic lens 100 while the ophthalmic lens 100 is carried by the lens carrier 232.

As shown in FIG. 6, the lens carrier 232 can be grasped or otherwise held by the end effector 246 of the robotic arm 240. In some embodiments, the robotic arm 240 can be configured or controlled by a computing device or control unit to translate the lens carrier 232 vertically in an up-and-down motion, repeatedly, when the ophthalmic lens 100 is being dried by the drying assembly 206.

In other embodiments, the robotic arm 240 can be configured or controlled by a computing device or control unit to translate the lens carrier 232 laterally in a back-and-forth or right-to-left motion, repeatedly, when the ophthalmic lens 100 is being blow dried by the drying assembly 206. In further embodiments, the robotic arm 240 can be configured or controlled by a computing device or control unit to translate the lens carrier 232 both vertically in an up-and-down motion and laterally in a back-and-forth or right-to-left motion, repeatedly, when the ophthalmic lens 100 is being blow dried by the drying assembly 206.

In some embodiments, the ophthalmic lens 100 can be blow dried by the drying assembly 206 for between 20 seconds and 100 seconds (e.g., between about 30 seconds and 60 seconds). In other embodiments, the ophthalmic lens 100 can be blow dried by the drying assembly 206 for less than 10 seconds, for between 10 seconds and 20 seconds, for between 100 seconds and 120 seconds, or for greater than 120 seconds.

The robotic arm 240 can transport or otherwise maneuver the lens carrier 232 to a space 602 in between the first air dry nozzle 224A and the second air dry nozzle 224B in order to blow dry the ophthalmic lens 100 carried by the lens carrier 232. The lens carrier 232 can be positioned substantially equidistant between the first air nozzle port 600A and the second air nozzle port 600B by the robotic arm 240 while the ophthalmic lens 100 is being dried.

As previously discussed, one or more processors of a computing device or a control unit can execute instructions stored in a memory unit or storage unit of the computing device or the control unit to control the robotic arm 240 to move the lens carrier 232 carrying the ophthalmic lens 100 to the space 602 in between the first air dry nozzle 224A and the second air dry nozzle 224B and the one or more processors can also execute instructions to control the drying assembly 206 to blow dry the ophthalmic lens 100 with compressed air while the lens carrier 232 is positioned within the space 602. In addition, the one or more processors can also execute instructions to control the robotic arm 240 to translate the lens carrier 232 vertically in an up-and-down motion (and/or laterally in a left-to-right motion or right-to-left motion), repeatedly, while the ophthalmic lens 100 is being blow dried. The one or more processors can further execute instructions to move the lens carrier 232 back to the lens carrier tray 230 or to another lens carrier tray once the ophthalmic lens 100 has been blow dried.

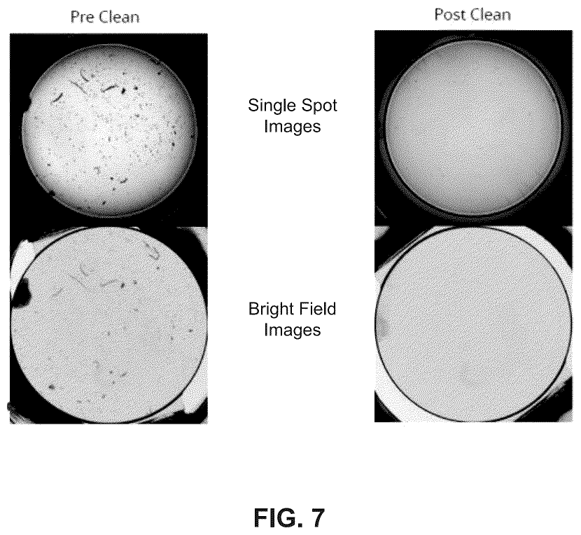

FIG. 7 are black-and-white single spot and bright field images showing an optic portion of one embodiment of an ophthalmic lens 100 before and after being cleaned by the automated cleaning system 200 disclosed herein. As shown in FIG. 7, the ophthalmic lens 100 appeared notably cleaner and free of debris and oil spots after being cleaned. FIG. 7 also shows that there was no visible damage to the ophthalmic lens 100 as a result of the cleaning procedure.

To achieve this level of cleanliness, the brush gap 410 was set to about 1.5 mm and the lens carrier 232 was translated laterally by the robotic arm 240 for a total distance of about 6.0 mm. The ophthalmic lens 100 was brushed for about 120 seconds by the brushing assembly 202, rinsed for about 120 seconds by the rinsing assembly 204, and dried for about 30 seconds by the drying assembly 206.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps or operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings may be regarded in an illustrative rather than a restrictive sense.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of”, when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially”, “about” and “approximately” as used herein mean the specified value or the specified value and a reasonable amount of deviation from the specified value (e.g., a deviation of up to ±0.1%, ±1%, ±5%, or ±10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

1. An automated system for cleaning an ophthalmic lens, comprising:
a brushing assembly, comprising:
a first brush head coupled to a first vibrating motor assembly configured to vibrate the first brush head,
a second brush head coupled to a second vibrating motor assembly configured to vibrate the second brush head,
wherein the first brush head faces the second brush head,
wherein the first brush head is separated from the second brush head by a lens receiving space, and
wherein at least a part of the first brush head and at least a part of the second brush head are configured to directly contact and brush the ophthalmic lens when the ophthalmic lens is positioned within the lens receiving space in between the first brush head and the second brush head as the brush heads vibrate;
a rinsing assembly comprising at least one rinse nozzle configured to spray the ophthalmic lens with a rinsing liquid after the ophthalmic lens is brushed by the brushing assembly; and
a drying assembly comprising at least one air dry nozzle configured to blow dry the ophthalmic lens after the ophthalmic lens is sprayed by the rinsing assembly.

2. The system of claim 1, wherein the first brush head comprises a plurality of first brush bristles, wherein the second brush head comprises a plurality of second brush bristles, and wherein the plurality of first brush bristles and the plurality of second brush bristles are made of polymeric fibers.

3. The system of claim 2, wherein the polymeric fibers are polyethylene terephthalate (PET) fibers.

4. The system of claim 2, wherein the plurality of first brush bristles are arranged in a frustonical shape, and wherein the plurality of second brush bristles are arranged in a frustonical shape.

5. The system of claim 1, wherein the first brush head comprises a first brush head distal end, wherein the second brush head comprises a second brush head distal end, wherein the brushing assembly further comprises:
a first electric sliding actuator configured to translate the first brush head toward the second brush head when the ophthalmic lens is positioned within the lens receiving space; and
a second electric sliding actuator configured to translate the second brush head toward the first brush head when the ophthalmic lens is positioned within the lens receiving space,
wherein the first electric sliding actuator and the second electric sliding actuator are configured to translate the brush heads toward one another until a brush gap separates the first brush head distal end from the second brush head distal end.

6. The system of claim 5, wherein the brush gap is between 0.3 mm and 2.0 mm.

7. The system of claim 6, wherein the ophthalmic lens comprises an optic portion having an optic portion thickness, wherein the brush gap is less than the optic portion thickness.

8. The system of claim 1, further comprising a surfactant drip configured to drip a surfactant solution onto at least part of the ophthalmic lens while the ophthalmic lens is being brushed.

9. The system of claim 8, wherein the surfactant solution is a 0.5% (v/v) solution comprising polysorbate 20.

10. The system of claim 8, wherein the surfactant solution is dripped onto the ophthalmic lens at a rate of between 3 mL per minute and 7 mL per minute.

11. The system of claim 1, wherein the rinsing liquid is deionized water.

12. The system of claim 1, wherein the ophthalmic lens is configured to be brushed by the first brush head and the second brush head for between 60 seconds and 120 seconds.

13. The system of claim 1, wherein the ophthalmic lens is configured to be rinsed for between 60 seconds and 200 seconds.

14. The system of claim 1, wherein the ophthalmic lens is configured to be blow dried for between 20 seconds and 100 seconds.

15. The system of claim 1, wherein the at least one air dry nozzle is an air knife and wherein the air knife is configured to blow dry the ophthalmic lens using compressed air.

16. The system of claim 1, further comprising a lens carrier configured to hold the ophthalmic lens in position while the ophthalmic lens is being cleaned.

17. The system of claim 16, wherein the lens carrier is configured to hold the ophthalmic lens by one or more haptics of the ophthalmic lens.

18. The system of claim 16, wherein the lens carrier comprises a first carrier part and a second carrier part, wherein the ophthalmic lens is configured to be positioned in between the first carrier part and the second carrier part when the first carrier part is detachably coupled to the second carrier part.

19.-30. (canceled)

31. A method of automatically cleaning an ophthalmic lens, comprising:
brushing a first side of the ophthalmic lens using a first brush head by vibrating the first brush head using a first vibrating motor assembly coupled to the first brush head;
brushing a second side of the ophthalmic lens using a second brush head by vibrating the second brush head using a second vibrating motor assembly coupled to the second brush head, wherein the first brush head faces the second brush head;
spraying the ophthalmic lens with a rinsing liquid using at least one rinse nozzle after the ophthalmic lens is brushed; and
blow drying the ophthalmic lens with at least one air dry nozzle after the ophthalmic lens is sprayed.

32.-60. (canceled)

61. A brushing assembly for cleaning an ophthalmic lens, comprising:
a first brush head;
a first vibrating motor assembly coupled to the first brush head and configured to vibrate the first brush head;
a second brush head facing the first brush head, wherein the first brush head is separated from the second brush head by a lens receiving space; and
a second vibrating motor assembly coupled to the second brush head and configured to vibrate the second brush head, wherein at least a part of the first brush head and at least a part of the second brush head are configured to directly contact and brush the ophthalmic lens when the ophthalmic lens is positioned within the lens receiving space in between the first brush head and the second brush head as the brush heads vibrate.

62.-77. (canceled)
